(19) United States
(12) Patent Application Publication
(10) Pub. No.: US 2016/0346617 A1
(43) Pub. Date: Dec. 1, 2016

(54) SYSTEMS, METHODS AND DEVICES FOR TRACKING WORKOUT RELATED INFORMATION

(71) Applicant: GYMTRACK INC., Ottawa (CA)

(72) Inventors: Pablo SRUGO, Ottawa (CA); Lee SILVERSTONE, Ottawa (CA); Aaron Michael RAMSEY, Woodlawn (CA); Mordechia Aryeh BRODT, Ottawa (CA)

(21) Appl. No.: 15/115,174

(22) PCT Filed: Jan. 30, 2015
(86) PCT No.: PCT/CA2015/050071

§ 371 Date: Jul. 28, 2016

Related U.S. Application Data
(60) Provisional application No. 61/933,452, filed on Jan. 30, 2014.
(60) Provisional application No. 61/990,979, filed on May 9, 2014.
(60) Provisional application No. 62/018,619, filed on Jun. 29, 2014.

(51) Int. Cl. A63B 24/00; A63B 21/075; G09B 5/12; A63B 23/04; G09B 19/00; A63B 21/062; A63B 21/078

(52) U.S. Cl. CPC A63B 24/0075; A63B 21/063; A63B 21/075; A63B 21/078; A63B 23/0405; G09B 19/0038; G09B 5/125; A63B 2220/40; A63B 2220/17; A63B 2225/54; A63B 2220/52; A63B 2220/833; A63B 2023/0411; H04W 4/008

(57) ABSTRACT

A workout system is described further herein that allows users of gym equipment to automatically track their workouts, as well as possibly receive real-time assistance related to their workouts. The system is not limited to any specific equipment, and can be used to track the weight used and number of repetitions performed on a variety of equipment, including, but not limited to, selectable weight stack machines, cable machines, barbells with removable weight plates, plate loaded machines, dumbbells, kettle bells and free weights.

### TECHNICAL FIELD

The current disclosure relates to providing workout related information, and in particular to systems, methods and devices for providing tracking of workout related information using generic weight lifting equipment.

### BACKGROUND

Workouts, whether in a commercial gym, a public gym or a private gym, typically include cardio portions and weight lifting portions. It may desirable to track workout related information for a number of reasons, including tracking progress, encouragement, identifying potential problems or areas of improvement as well as other reasons.

Hardware devices, such as bracelets, may be used to track repetitive movements and may be helpful in tracking cardio portions of a workout, such as running on a treadmill. However, these devices are not able to readily track information for a weight lifting portion since the devices do not include any information about an amount of weight being lifted. While it is possible for the user to manually enter the weights, either before, during or after a workout, such extra steps are often cumbersome and prone to error.

Certain weight lifting machines may include tracking systems for tracking an amount of weight being lifted and the number of repetitions. However, such tracking systems are typically designed for specific machines and cannot be easily used with different machines. Further, such systems provide no ability to track information related to free weights.

It would be desirable to have additional, alternative and/or improved systems, methods and devices for tracking workout related information for generic weight lifting equipment.

### SUMMARY

In accordance with the present disclosure there is provided a system for tracking workout related information comprising: a wearable device comprising: a wireless communication module; and a processor for executing instructions stored in memory, which when executed configure the wearable device to: identify a piece of workout equipment in close proximity to the wearable device; and receive workout information related to use of the identified piece of workout equipment; and an equipment device associated with the piece of workout equipment comprising: a wireless communication module; and a processor for executing instructions stored in memory, which when executed configure the equipment device to: determine the workout related information comprising an associated weight being used with the piece of workout equipment; and transmit the workout information.

In accordance with the present disclosure there is further provided a removable plate equipment device for use in providing workout related information to a wearable device, the removable plate equipment device comprising: a housing sized to fit within an opening of a removable weight plate and comprising an end for securing to an end of a weight plate receiving bar; a plate sensor for detecting when a removable weight plate is being added or removed; a tag reader for reading an identification tag located at the opening of the removable weight plate of the removable weight plate passing over the tag reader; a processor for executing instructions stored in memory, which when executed cause the removable plate equipment device to be configured to: detect when the weight plate is being added or removed and enable the tag reader; receive a signal from the tag reader and determine an amount of weight associated with the removable weight plate; and update an amount of weight associated with the weight plate receiving bar; and a wireless communication interface for transmitting workout information comprising the updated amount of weight associated with the weight plate receiving bar.

In accordance with the present disclosure there is further provided a selectable plate equipment device for use in providing workout related information to a wearable device, the selectable plate equipment device comprising: a pin for selecting a number of plates to be used in a piece of selectable plate workout equipment; a range finder device for determining a distance from a stationary reference point to the pin during use of the selectable plate workout equipment; a processor for executing instructions stored in memory, which when executed cause the selectable plate equipment device to be configured to: receive signals from the range finder and determine a selected amount of weight; and a wireless communication interface for communicating to the wearable device workout information comprising the selected amount of weight selected by the pin.

In accordance with the present disclosure there is further provided a method of providing virtual training to a user comprising: receiving a workout plan for the user identifying a plurality of exercises, one or more of the plurality of exercises comprising an indication of a piece of equipment, and associated weight and a number of repetitions; providing instructions to the user regarding at least one unperformed exercise of the workout plan; receiving workout information from a wearable device of the user providing an indication of a piece of equipment being used, an amount of weight be used and repetition information; comparing the received workout information to the workout plan; and providing feedback to the user based on the comparison.

In accordance with the present disclosure there is further provided a near-field communication (NFC) tag comprising: a body defining an internal opening; a wire loop antenna surrounding the internal opening of the body; and NFC circuitry connected to the wire loop antenna.

### BRIEF DESCRIPTION OF THE DRAWINGS

Embodiments are described herein with reference to the appended drawings, in which:

FIG. 1 depicts components of a system for tracking workout related information;

FIG. 2 depicts components for tracking workout related information on a selectable weight plate machine;

FIG. 3 depicts further components for tracking workout related information on a selectable weight plate machine;

FIG. 4 depicts further components for tracking workout related information on a selectable weight plate machine;

FIG. 5 depicts components for tracking workout related information on a removable weight plate machine;

FIG. 6 depicts further components for tracking workout related information on a removable weight plate machine;

FIG. 7 depicts components of an NFC tag for use with removable weight plates;

FIG. 8 depicts a schematic of a housing fixture for a removable plate device;

FIG. 9 depicts an exploded schematic of the housing fixture of FIG. 8;

FIG. 10 depicts a process flow of the system for tracking workout related information;

FIG. 11 depicts a process flow for tracking workout related information on a selectable weight plate machine;

FIG. 12 depicts a process flow for tracking workout related information on a removable weight plate machine;

FIG. 13 depicts auxiliary components for use with pieces of auxiliary workout equipment;

FIG. 14 depicts a shoe sensor;

FIG. 15 depicts a wearable device for determining exercise information;

FIG. 16 depicts a process for providing workout instructions using the system for tracking workout related information;

FIG. 17 depicts a device for providing workout instructions using the system for tracking workout related information; and

FIG. 18 depicts a system for augmenting workout instructions.

### DETAILED DESCRIPTION

A workout system is described further herein that allows users of gym equipment to automatically track their workouts, as well as possibly receive real-time assistance related to their workouts. The system is not limited to any specific equipment, and can be used to track the weight used and number of repetitions performed on a variety of equipment, including, but not limited to, selectable weight stack machines, cable machines, barbells with removable weight plates, plate loaded machines, dumbbells, kettle bells and free weights. Aside from tracking workout related information, the system may also be used to provide feedback to the user in real-time, such as, but not limited to, the weights used and repetitions performed on a given exercise when a given exercise was previously performed by the user, a countdown that allows the user know when to perform the next set of a given exercise or the next exercise, an indication of available equipment, as well as auditory feedback or other feedback similar to what would be given by a personal trainer, such as encouragement or identification of possible problems with performing the exercise. As described further below, the system for tracking workout related information allows tracking of workout related information including an amount of weight used and a number of repetitions performed across a wide variety of weight lifting equipment, including both selectable weight lifting equipment, in which a user inserts a pin into the equipment to select a number of weight plates to be used, and removable weight lifting equipment, in which the user adds or removes weight plates from a bar to obtain the desired amount of weight. In addition to the tracking workout related information such as the weight used and number of repetitions, the system may also track other workout related information such as a range of motion, time under tension, intensity, etc. The system may also provide tracking of workout related information when using dumbbells as well as other auxiliary weight lifting equipment such as a weight lifting bench, balls and/or ropes.

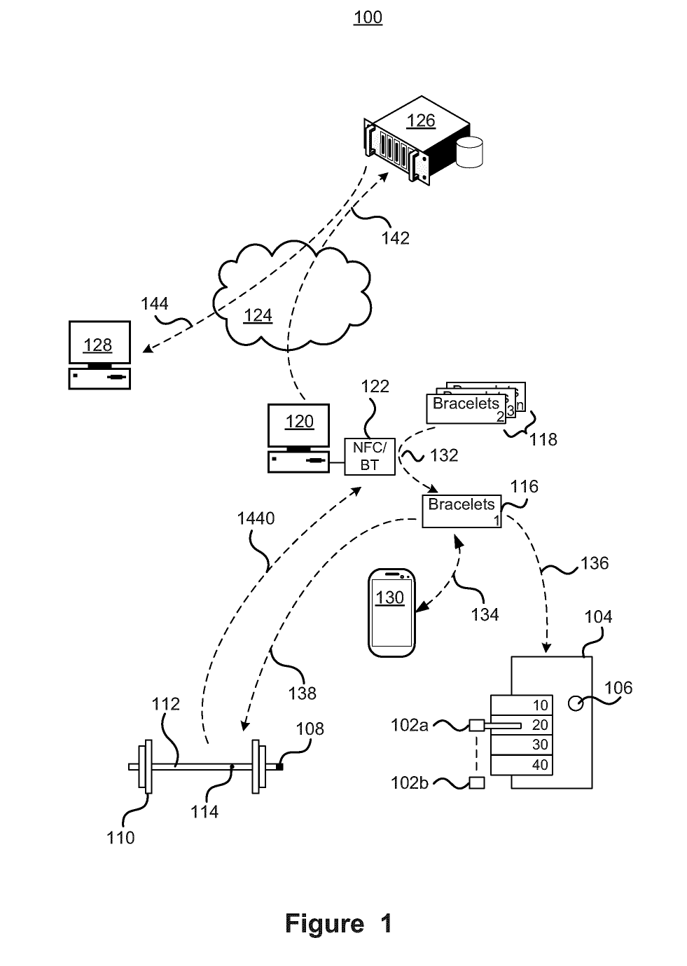

FIG. 1 depicts components of a system for tracking workout related information. The system 100 comprises a number of different pieces of hardware, some of which are installed directly onto gym equipment, and others which are worn by the user. As depicted in FIG. 1, the components include, but are not limited to, a weight stack selector pin 102a and a corresponding floor unit 102b. The weight stack selector pin 102a and floor unit are associated with a particular piece of workout equipment 104, which may include a near-field communication (NFC) tag or similar tag 106, such as a Bluetooth® low energy (BLE) tag, barcode tag, a QR code tag or a color code tag for use in identifying the equipment. The weight stack selector pin 102a and corresponding floor unit 102b may provide a selectable weight stack device (referred to collectively as selectable weight stack device 102) that determines an amount of weight selected based on distance information between the pin 102a and the floor unit 102b.

The system 100 may further comprise a barbell attachment 108, or a removable weight plate device 108 that determines an amount of weight 110 added or removed from a bar 112. The bar 112, or the barbell attachment 108, may also include a tag 114 for use in identifying the bar 112.

The system 100 may further comprise a bracelet 116, or wearable device, that is worn by the user and communicates with other components, such as the selectable weight stack device 102 or the removable weight plate device 108, in order to track workout information for a user.

It is contemplated that the system 100 may be used in a home environment, that is an environment that includes a limited number of selectable weight machines for example a single, multi-purpose weight machine, and a relatively small selection of removable weight plate equipment. In such an environment, a single wearable device 116 may be sufficient since multiple users may not be present in the gym at the same time. However, it is contemplated that the system 100 may be used in gyms that include a number of pieces of weight lifting equipment, in which case each piece of equipment, or at least a plurality of pieces of equipment, are equipped with respective weight stack selector devices 102 or removable weight plate devices 108. Although described primarily with regard to selectable weight machines or removable weight plate equipment, the system 100 may also be used with fixed weights such as dumbbells, kettle bells, etc. A tag, such as an NFC or BLE tag may be placed on the fixed weight and used to identify the equipment. The tags placed on the fixed weight may be passive tags or may incorporate sensors such as accelerometers and/or gyroscopes for detecting movement which can be used in determining movement of the fixed weight. The equipment tag device on a fixed weight piece of equipment may track workout related information and communicate the information to a user's wearable device or may communicate the information to another computing device for storage and/or processing. The system may also be used for tracking workout related information not associated with weights such as cardio activities or stretching activities. Further a plurality of bracelets 118 may be provided so that each user in the gym may be able to use a bracelet and so benefit from the ability to track workout related information. Additionally or alternatively, it may be possible for the system to function with bracelets, or other wearable devices, of the user.

The system 100 may further comprise a computing device 120 at the gym facility in order to manage assignments of the bracelets 118. The computing device 120 may be provided by a low power computing device, such as a raspberry-pi based computer, personal computer or one or more co-operating personal computers or servers and may be used to provide additional functionality to the gym if desired. For example, the computing device 120 may include user tracking functionality for verifying that a user has paid a gym membership, or may provide scheduling functionality for the gym as well as any other desired or required functions. The computing device may include wireless communication interfaces, including for example an NFC reader as well as Bluetooth functionality. The NFC reader may be used to read bracelet identifiers when assigning a bracelet to a user, as well as possibly reading a user identifier from a gym token or other identification token. Further, it is possible for the bracelet to be used to gain access to the facility or access equipment. The Bluetooth functionality, which may include Bluetooth Low Energy functionality, may be used to establish a wireless communication channel between a bracelet, such as bracelet 116, and the computing device 120 following a user's workout in order to transfer any stored workout related information. Alternatively, the workout related information may be wirelessly communicated to the computing device 120 for storage during the workout.

The computing device 120 may be connected to a network 124, such as the Internet, which allows the computing device 120 to communicate with a networked computing device 126 that may receive and store workout related information associated with a user from the computing device 120. The networked computing device 126, or another networked computing device (not shown) that is communicatively coupled to the networked computing device 126, may provide a user interface that allows a user to access and view workout related information from a remote computing device 128.

The computing device 120 may be provided by an existing computer at a gym facility. Alternatively, the computing device 120 may act as a network gateway for communicating information to a remote computer device, such as the network computing device 126, which may provide functionality described herein as being provided by the gym computing device 120. One of ordinary skill in the art will readily appreciate a wide number of options for providing the computer functionality described herein using traditional, and well understood, networking techniques.

The system 100 may further include functionality present on a user's portable device 130 such as their cellular telephone, that can provide real-time, or near real-time information to the user regarding their workout. As an example, the user's portable device may include functionality for receiving workout related information from a bracelet worn by the user and comparing the workout related information to a workout plan on the portable device. Based on the comparison the functionality may provide instructions or feedback to the user for their workout, such as a number of remaining repetitions for a certain exercise, or the next exercise to be performed. The cellular phone may also transmit workout related information to the networked computing device 126, or it may be downloaded to a user's computing device 128. Although described separately, it will be appreciated that the functionality of the bracelet and the portable device may be combined together into a single device.

As depicted in FIG. 1, a user may be assigned a bracelet 116 from a plurality of available bracelets 118 when starting their workout. When the bracelet is assigned, the computing device 120 retrieves an identifier associated with the bracelet, for example using the NFC reader 122, and associates the bracelet ID with the user, depicted schematically by dashed arrow 132, so that subsequent workout related information received by the computing device may be associated with the user. Although depicted as associating a user ID with the bracelet ID, it is contemplated that the system does not need to associate a user ID with the bracelet ID, however subsequent association of the workout related information received at the computing device 120 may not be able to be associated with the particular user. This may be desirable to users who do not wish for any workout related information to be associated with them for privacy concerns, or any other reason. Alternatively, the bracelets 118 may include functionality for associating the user ID with the workout related information, which although not required may then be communicated to the computing device 120. For example, the bracelets 118 may include NFC reader functionality, which may read a user's ID from a gym token, similar tag or assigned passive rubber bracelet and subsequently associate captured workout related information with the user's ID.

Once the bracelet 116 is assigned to a user, and if the user is utilizing a portable device 130, the bracelet 116 may be associated with the user's portable device. The association may be provided in numerous ways, including for example a Bluetooth pairing process that establishes a wireless communication channel between the bracelet 116 and the portable device 130. Once the wireless communication channel is established, workout related information may be communicated from the bracelet 116 to the portable device 130. If the communication of workout related information is done in real-time, or near real-time it may be processed by the portable device 130 in order to provide real-time feedback to the user regarding their workout. The feedback may be dependent upon the workout related information. As an example, if the processing of the workout related information indicates that the user is slowing down towards the end of an exercise, the feedback may be motivational in nature, encouraging the user to complete the exercise. If the processing the workout related information indicates that an exercise has been completed, the feedback may include information on a subsequent exercise to perform, which in turn may be determined by the portable device using a workout plan.

When a user uses a piece of equipment, such as a selectable weight stack machine 104, the user identifies the equipment to the bracelet 116, for example by tapping, or otherwise scanning or detecting, an identification tag 106 associated with the equipment. If the piece of equipment is associated with multiple possible exercises, multiple tags, each possibly associated with an icon or information indicating an exercise, may be provided and the desired tag selected. When the bracelet is tapped to the tag, or the tag otherwise read or detected, the exercise equipment identifier may be used in order to establish a wireless communication channel, for example using Bluetooth, or Bluetooth Low Energy between the equipment 104, or more particularly the weight stack selector device 102, and the bracelet 116. The communication channel is used to communicate workout related information to the bracelet that includes weight selection information, depicted by dashed arrow 136. The workout related information communicated by the weight stack selector device 102 may also include repetition count information. The weight stack selector device 102 may determine both the selected weight information and the repetition information based on a distance the weight stack selector device 102 is from a stationary reference point throughout the exercise. The weight stack selector device 102 may be calibrated during a calibration process in order to associate a distance from the reference point with a particular selected weight.

Once the user has completed an exercise they may move to another piece of equipment to perform a subsequent exercise. The equipment may include removable weight plate equipment 112. The bracelet may again be associated with the piece of equipment, for example tapping, or detecting, a tag 114 on the piece of equipment. A wireless communication channel is again established between the bracelet and the weight tracking device of the equipment, which in the case of the removable weight plate equipment 112 is the removable weight plate device 108. The removable weight plate device may maintain weight information indicative of a current weight on the bar 112. As described in further detail below, as weight plates are added or removed, the weight associated with the equipment 112 may be updated by the removable weight plate device 108. The removable weight plate device 108 communicates the workout related information, which includes the weight information to the bracelet 116 over the wireless communication channel, depicted as dashed arrow 138. The removable weight plate device 108 may also track repetition count information, for example using accelerometers and/or gyroscopes in the weight plate device 108, and include the repetition count information to the bracelet 116 in the workout related information. Additionally or alternatively, the bracelet 116 may track the repetition count information, using accelerometers and/or gyroscopes in the bracelet. Additionally or alternatively, if paired to the bracelet, the portable device 130 may determine repetition count information using accelerometer and/or gyroscope information provided by the bracelet 116 and/or the weight plate selector device 108. The portable device 130 may have increased processing power compared to either the selector device 108 or the bracelet 116 and as such may be able to process the accelerometer and/or gyroscope data more fully in order to identify repetition counts. Further, the portable device 130 may include additional information, such as a workout plan that may allow improved repetition count detection by providing additional information such as which exercise the user is supposed to be performing based on a workout plan. Alternatively, if the user has not paired a portable device 130, the accelerometer and/or gyroscope data may be temporarily stored and provided for subsequent processing by either the gym computing device 120, the networked computing device 126 and/or the user's computing device 128, which may allow for more detailed repetition count identification due to increased processing power, as well as increased available information.

Once the user has completed their workout, the bracelet may be returned and check back in using the gym computing device 120. The gym computing device 120 may establish a communication channel with the bracelet, for example using Bluetooth or Bluetooth Low Energy, in order to transfer the workout related information, which includes information about the weight used for each exercise as well a repetition count related information, which may be actual repetition counts, or data, for example from the accelerometers and/or gyroscopes, that can be subsequently processed to identify actual repetition counts. The workout related information may then be transferred for access by the user. The workout related information may be transferred to the networked computing device 126, depicted by dashed arrow 124, which may store the information for subsequent access by a computing device 128 of the user, depicted as dashed arrow 144. Additionally, or alternatively, the workout related information may be provided to the user or a computing device associated with the user, in various manners, including for example, computer readable media such as flash drives, email, as well as direct connections between the user's computing device and the gym's computing device 120.

In addition to being useful to gym users for tracking their workout related information, the workout related information may also be useful to personal trainers and/or gym owners. The workout related information may be viewed by, for example gym owners, gym operators, gym managers to view the workout related information based on either individual data of users, aggregate data of all users, a selected subset of users or based on other groupings or views of the workout related information. Further, the workout related information may also be used to provide information on equipment use, which may be helpful in identifying equipment that may need maintenance or replacing as well as planning new equipment purchases. The data may also be used for other purposes such as holding competitions within the gym or within other groups, such as friends, user's in a given geographic location, etc.

The above description is intended to provide details with regard to the interaction of various components of the system 100. It will be appreciated that not all described components are necessary for a system that provides some level of tracking of workout related information. For example, a single bracelet 116 and a single weight stack selector device 102 may provide acceptable tracking of workout related information in certain scenarios, such as in a home environment with a single multi-purpose weight stack machine. Alternatively, a single bracelet 116 and a single removable weight device 108 may provide acceptable tracking of workout related information in certain scenarios, such as in a home environment with only free weights. In a typical gym environment, a system 100 would typically, although not required, include a number of bracelets 116, a number of weight stack selector devices 102 and a number of removable weight plate devices 108. It will be appreciated that additional components described above, as well as those subsequently described below, may be incorporated into a system in order to provide desired functionality based on particular requirements.

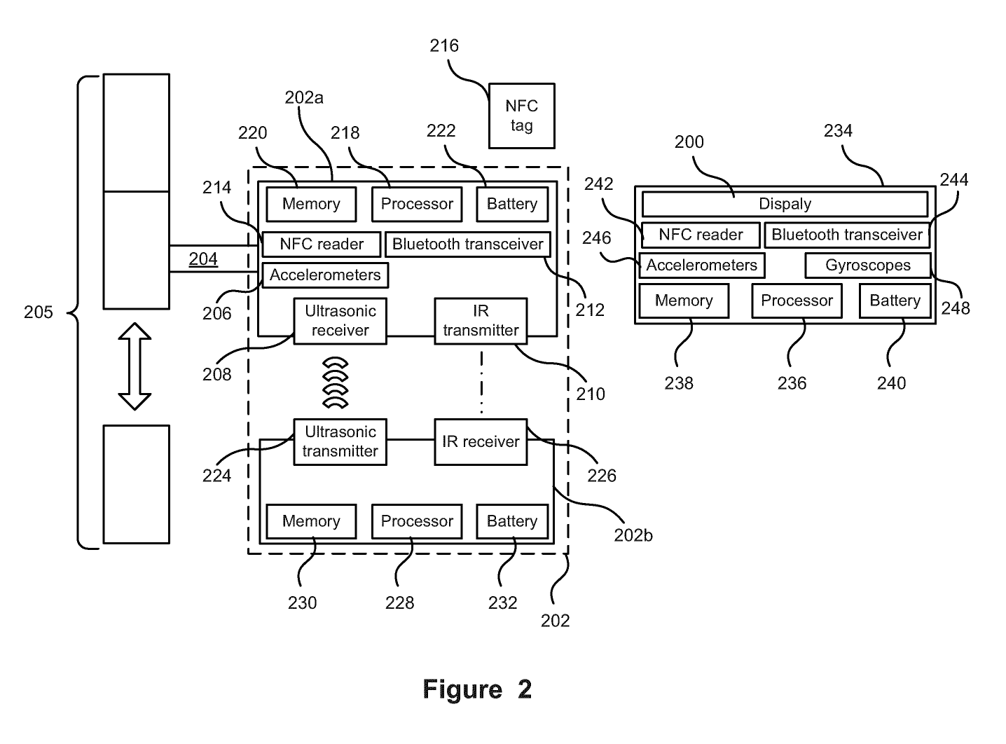

FIG. 2 depicts components for tracking workout related information on a selectable weight plate machine. A weight stack selector device 202 is depicted as comprising a weight stack selector pin unit 202a and a floor unit 202b; however, as described, the weight stack selector device 202 may be provided by a single selector pin unit, or a single floor unit. The weight stack selector pin unit 202a resembles selector pins currently used on weight stack machines. These pins are inserted into the desired weight stack by the user, in order to allow him/her to lift the desired amount of weight. The stack selector pin unit 202a works in a similar fashion and includes a pin 204 sized to work with weight stack machines. The weight stack selector pin unit 202a includes a housing connected to the pin 204 that houses electronic components of the weight stack selector pin unit 202a. The electronics of the weight stack selector device 202 may include various sensors that allow the weight stack selector device to determine, amongst other things, which weight stack has been selected. The various sensors may also allow the weight stack selector device 202 to determine, for example, how many repetitions have been performed, which user is using the machine, the proper range of motion, the correct speed, etc.

As depicted in FIG. 2, each weight stack selector device 202 may be divided into two separate units, namely a selector pin unit 202a and a floor unit 202b. The floor unit may be placed directly under the weight stack selector pin unit 202a when it is inserted into a weight stack 205. The floor unit 202b may be placed on the floor or on a bar that is part of the weight stack machine itself. The floor unit 202b may provide a stationary reference point that allows the selector pin unit 202a to determine a distance throughout the exercise, which in turn can be used to determine a selected weight, as well as a number of repetitions. It will be appreciated, that although the floor unit 202b is described as providing a reference point for determining a distance travelled, it is possible for the selector device 202 to only use a selector pin unit 202a and determine a distance travelled relative to other stationary reference points, such as the floor or a frame of the machine. Alternatively, the selector device 202 may use a floor sensor 202b that detects the distance to a normal selector pin, that is a passive selector pin.

As depicted, the selector pin unit 202a may comprise one or more accelerometers 206 for detecting movement. Although not depicted, it is possible for the selector pin unit 202a to also include one or more gyroscopes to detect a rotational position of the selector pin. Depending upon the shape of the selector pin, its rotational position may affect the distance detected to the floor or floor unit. The weight stack selector pin unit 202a may further comprise an ultrasonic receiver 208, although an ultrasonic transmitter or transceiver could be used instead depending upon the presence of the floor unit 202b, that may be used as a range finding device in order to determine distances between the selector pin unit 202a and a stationary reference point, such as the floor unit 102b when present, or the floor itself when no floor unit is present. The selector pin unit may also comprise an IR transmitter 210, a wireless communication interface such as a Bluetooth or Bluetooth Low Energy module 212, and possibly an NFC tag or NFC tag reader 214. If the selector pin unit 202a comprises an NFC tag reader, an NFC tag 216 may be placed on the machine in order to identify the machine to the selector pin unit 202a and allow the selector pin unit 202a to use appropriate calibration information for the particular machine in order to determine the selected weight based on distance information. The functionality of NFC reader and NFC tag may be provided by similar technologies such as BLE radios and tags. Alternatively, if the selector pin unit 202a does not include an NFC reader, the selector pin unit 202a may be calibrated manually the first time it is used with a different machine. The selector pin unit 202a may include a NFC tag in order to identify the machine to a bracelet. Alternatively, the NFC tag 216 or other type of tag, if present on the machine may be used to identify the machine to the bracelet.

The selector pin unit 202a may further include a processor or microcontroller 218 and associated memory 220 and battery 222. The processor or microcontroller 218 executes instructions stored in the memory 220 in order to provide functionality described herein.

In order to provide a more robust system, the weight stack selector device 202 is provided by two co-operating components, namely the selector pin unit 202a described above and the floor unit 202b. The floor unit 202b may comprise an ultrasonic transmitter 224, although an ultrasonic receiver or transceiver could be used instead, and an Infrared (IR) receiver 226. The floor unit may further include a processor or microcontroller 228 and associated memory 230 and battery 232. The processor or microcontroller 228 executes instructions stored in the memory 230 in order to provide functionality described herein.

The weight stack selector pin unit 202a and the floor unit 202b work together to determine which weight stack has been selected, and how many repetitions have been performed. In the embodiment depicted in FIG. 2, the ultrasonic receiver 208 on the selector pin unit 202a receives ultrasonic pings from the floor unit's ultrasonic transmitter 224, but does not send pings itself. It is contemplated that the ultrasonic transmitter could be located in the selector pin unit and the ultrasonic receiver could be located in the floor unit 202b, in which case the selector pin unit 202a may send out pings, and the floor unit would receive pings. The range finder device provided by the ultrasonic transmitter 224 and receiver 208 of the weight stack selector device 202 allow a distance between the transmitter and receiver to be determined throughout the range of the exercise. The distance information at the start and/or end of the exercise may be used to provide an indication of the weight stack selected. The distance information throughout the exercise may be used to provide an indication of the number of repetitions.

Although described above as using a range finding device to determine distance, and from the distance the weight selected and repetitions, it is contemplated that the accelerometer of the selector pin unit 202a could be used to count repetitions, and color stickers, barcode stickers or NFC tags or other tags such as BLE tags or Radio Frequency Identification (RFID) tags, could be placed on each weight stack and read by a color sensor, barcode reader, NFC reader, Bluetooth radio or RFID reader in the selector pin unit. Further, it is contemplated that the floor unit 202b may be removed and only one ultrasonic transceiver, in the weight stack selector pin 202a, could be used, either pointing down to the floor or up to the ceiling or other vertically offset stationary reference point. Further, it is possible for the floor unit to determine the distance to a passive selector pin using an ultrasonic transceiver or other range finding technique such as a laser-based range finder.

It is further contemplated that other types of distance measurement sensors, such as infrared-based, or laser-based, or image-based distance measurement sensors, could be used instead of ultrasonic sensors. The distance measurement sensors could be replaced by a mechanical device, mounted on top of the topmost weight stack and adjacent to one of the vertical metal bars which form part of the weight stack machine itself. This mechanical device could include a rolling wheel or similar structure, which would roll against the metal bar as the weight stack moves up and down. In this case, the system would calculate the number and direction of the rotations of the rolling wheel in order to calculate the number of repetitions. In another embodiment, the selector pin unit could be connected by a wire to the floor and as the weight stack moves up the wire may stretch out and the tension measured in order to determine both the number of repetitions and the weight selected by the user.

In order to extend the operating time of the selector pin unit 202a and the floor unit 202b of a given weight stack machine, if the weight stack machine is not in use, both the selector pin unit 202a and the floor unit 202b may be placed in a low power sleep mode. When in the sleep mode, unnecessary components or functions may be temporarily turned off, or their power consumption otherwise reduced, in order to consume less power. In the low power state, the selector pin unit 202a may continue to power and monitor the accelerometer 214. When the accelerometer detects motion, it activates the selector pin unit 202a, which may then send an IR signal, or signals to the floor unit. As soon as the floor unit detects the IR signal, it wakes up as well. Once both units are woken up, that is both are placed in a fully operational state which consumes more power than when in the lower power sleep state, the weight stack selector device 202 is ready to start taking distance measurements.

The IR transmitter in the selector pin unit 202a may send an IR signal to the floor unit each time an ultrasonic ping should be sent to make a distance measurement. The ultrasonic sensor in the floor unit 202b may only send a signal once it receives an IR signal, thereby allowing the system to infer the distance between the selector pin unit 202a and the floor unit 202b by measuring an amount of time lapsed from the time when the weight stack selector pin sends an IR signal, to the time when the weight stack selector pin receives an ultrasonic signal from the floor unit. This distance measurement technique may be used when the weight stack selector pin is moving in order to count repetitions, as well as when the weight stack selector pin is at rest, for example when first inserted into the weight stack prior to the user lifting the weight in order to determine which weight is selected by the user.

Although described as being synchronized using an IR signal, it is contemplated that the weight stack selector pin 202a and the floor unit 202b could be synchronized using a wire or some form of Radio Frequency (RF) module or Bluetooth Low Energy module, instead of using the IR transmitter and receiver. Further still, the floor unit 202b may be configured to periodically send pings at a specific frequency and the distance information may be determined based on change in reception rate of the pings.

As further depicted in FIG. 2, a bracelet 234 interacts with the weight stack selector device 202. The bracelets 116, 118 may be provided by a bracelet similar to bracelet 234. The bracelet 234 may include a processor or microcontroller 236 and associated memory 238 and battery 240. The processor or microcontroller 236 executes instructions stored in the memory 238 in order to provide functionality described herein. The bracelet may further include an NFC reader 242, and a wireless communication interface such as a Bluetooth or Bluetooth low energy module 244. The bracelet may also include sensors for detecting motion of the bracelet, such as one or more accelerometers 246 and/or one or more gyroscopes 248, as well as other sensors such as magnetometers, barometers, thermometers, etc. The bracelet may further include a display 250 or other output device for providing information to the user. Additionally, the display 250 may be a touch sensitive display to allow the user to interact with the bracelet.

When an NFC reader 242 of the bracelet 234 is brought into close proximity with the NFC tag in the weight stack selector pin if present or the NFC tag on the machine 216, the NFC reader in the bracelet detects the NFC tag allowing the system to determine that the user is currently at a particular machine. The bracelet can also read NFC tags placed elsewhere on weight stack machines in order to determine that the user is currently at that machine. Further, if multiple exercises are possible with a single piece of equipment, multiple NFC tags may be provided on the equipment and associated with appropriate identifiers to allow the user to select the desired exercise.

Once the particular machine is identified, the wireless communication interface may then used to transmit workout related information from the weight stack selector device, or more particularly the selector pin 202a as depicted in FIG. 2, to the bracelet 234 worn by the user who is at that machine. Connection information for use in establishing the wireless communication channel with the particular machine may be provided by, or associated with the NFC tag. The transmitted workout related information may include selected weight information indicating an amount of weight selected, as well as repetition count information, indicating a number of repetitions performed. The workout related information may provide the selected weight information and the repetition count information explicitly, or it may provide information that may be used, for example by the bracelet, user's portable device or other computing devices, to determine the selected weight information and the repetition information.

If the user has paired the bracelet to his/her portable device, for example using Bluetooth Low Energy, the workout related information may be transferred to the user's phone where it may processed further. Additionally or alternatively, the workout related information may be temporarily stored until it can communicate the workout related data to another computing device for further processing, such as computing device 120, described above with reference to FIG. 1. The computing device 120 may act as a gateway and forward the workout related information onto another computing device such as networked computer device 126 described above with reference to FIG. 1.

Although the above has described various processing of information being carried out at specific components, it is contemplated, that the processing may be carried out at other components based on the processing requirements, and abilities of the individual components.

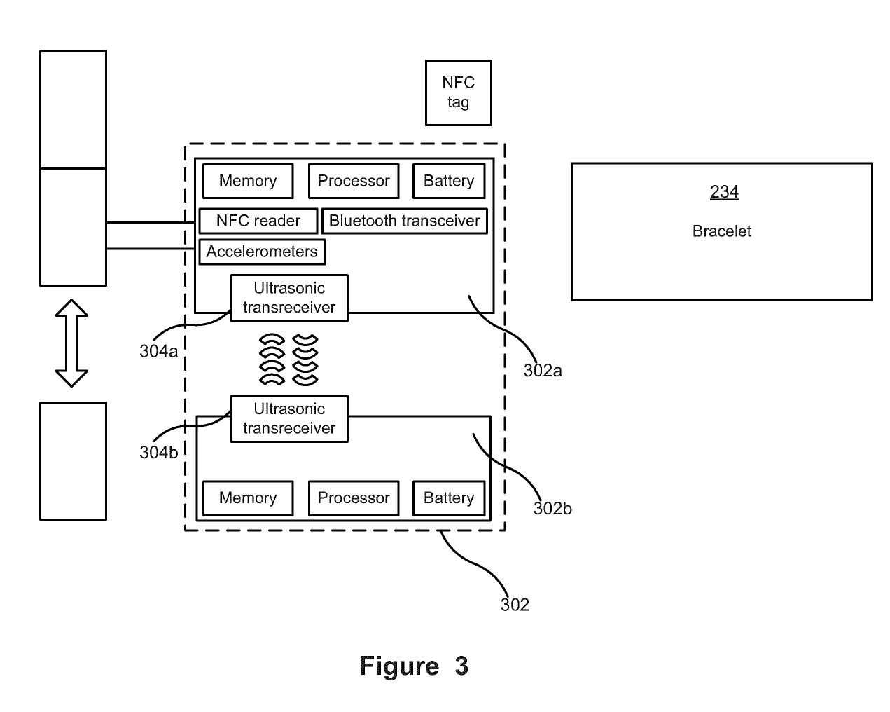

FIG. 3 depicts further components for tracking workout related information on a selectable weight plate machine. The weight stack selector device 302 is substantially similar to the weight stack selector device 202 with regard to functionality. Accordingly, similar components between the two devices, which are not labelled in FIG. 3, are not described in further detail and only those differences between the devices are described. Similar to the weight stack selector device 202, the weight stack selector device 302 comprises a pin unit 302a and a floor unit 302b, although the floor unit 302b could be omitted. In comparison to the weight stack selector device 202, the weight stack selector device 302 replaces the ultrasonic receiver/transmitter 208/224 and IR transmitter/receiver 210/226 with ultrasonic transducers 304a, 304b (referred to collectively as ultrasonic transducers 304). Each of the pin unit 302a and floor unit 302b comprise a respective one of the ultrasonic transceivers 304. In operation, when the pin unit 302a detects movement from the accelerometers the unit wakes up and begins transmitting ultrasonic pulses. The pin unit may, for example transmit a series of 20 pulses at 40 kHz. Once the pulses have been transmitted the pin unit 302a switches the transducer 304a to a receive mode waits for a period of time to allow any echoes from the transmitted pulses to dissipate. The time waited may be, for example approximately equal to the flight time of the ultrasonic pulses travelling approximately 10 meters. The floor unit 302b, or more particularly the transducer 304b of the floor unit 302b, receives the pulses and transmits a series of ultrasonic pulses in response after waiting the predefined period of time. The floor unit 302b may cause the ultrasonic transducer 304b to transmit a series of, for example, 20 pulses at 40 kHz. The ultrasonic transducer 304a of the pin unit 302a, which switches to the receive mode following transmitting the pulses, receives the pulses and determines a distance between the pin unit 302a and the floor unit 302b based on the time difference and accounting for the wait time between when the floor unit detects the pulses and begins transmitting. The process of measuring the distance between the floor unit and the pin unit may described above may take approximately 0.03 seconds, which is mainly due to the wait time used to allow echoes to dissipate. The weight stack selector device 302 may make a number of distance measurements each second when in use. For example, the weight stack selector device 302 may make 10 distance measurements per second. In between each distance measurement, the pin unit and floor unit may go to sleep or otherwise enter a lower powered state.

The first distance measurements made following the pin insertion may be used to determine a weight plate selected by the pin unit 302a, and as such the amount of weight being used for an exercise. The weight stack selector device 302 may include a calibration table specific to particular machine the pin is being used with. The calibration table provides a correspondence between distances and selected weights. The calibration unit may be determined by the pin unit during a calibration phase, or may be downloaded into the pin unit from an external computing device. For example, when a weight stack selector device 302, or more particularly the pin unit 302a, is placed with a piece of equipment, the pin unit 302a may read an NFC tag, or other tag or code associated with the piece of equipment to determine an identifier of the piece of equipment and communicate with a remote computing device that stores the calibration table associated with the ID of the equipment. The calibration table for the particular piece of equipment may be wirelessly downloaded into the pin unit. It may also be possible for one or more calibration tables to be downloaded into the pin unit to allow the pin unit to operate with multiple different pieces of equipment without requiring downloading an appropriate calibration table each time.

In addition to determining the distance between the pin unit 302a and the floor unit 302b, the weight stack selector device 302 may also determine a number of repetitions of the exercise, as well as possibly a tempo associated with performing the exercise. Generally, weight stack machines move the selected weight plates up and down vertically throughout a range of the exercise. During a repetition, the weight will transition from rising, dwelling at the top, falling, and dwelling at the bottom. The repetitions of the exercise may be determined based on the velocity of the motion. For example, distance measurements may be averaged out and any noisy, or outlying, measurements may be discarded. From the distance measurements, velocity information can be determined and used in identifying a rise state, during which the velocity may be assumed to be positive (or negative), a top dwell state, which immediately follows the rise state and has an approximately zero velocity, a fall state, which immediately follows the top dwell state and has a negative (or positive) velocity and a bottom dwell state, which immediately follows the fall state and as an approximately zero velocity. The velocity information obtained from the distance measurements may be used to transition between each of the described states in order to determine a single repetition, which may be considered as starting at the bottom dwell state and sequentially transitioning to the rise state, the top dwell state, the fall state and returning to the bottom dwell state. In addition to the transition between states used to determine the repetitions as described above, the time spent in each state may be determined and used in providing tempo information for the exercise.

The workout information tracked by the weight stack selector device may be transmitted from the weight stack selector device periodically. For example, the information may be communicated upon completing an exercise, upon each repetition, upon a transition to a different state, upon each measurement or some other interval or schedule. If, for example, the weight stack selector device transmits workout information upon each measurement, the information may include, for example, an indication of the weight being used, a current displacement distance from the floor unit, a current state within a particular repetition, the number of repetitions performed, a time value and an indication of the tempo. It will be appreciated that more information, or less information, may be determined and/or transmitted. Although described as determining a weight selected, as well as the workout related information at the weight stack selector device itself, it is possible to transmit the distance information to an external device, such as a bracelet 234, personal computing device or other computing device, which may in turn determine the workout information. After a period of inactivity, or upon detecting a pin insertion or removal event, the values associated with the workout information may be cleared. Generally, the axis of movement for inserting and/or removing the pin is orthogonal to the axis of movement of the pin during an exercise, and as such movement associated with a pin removal and/or insertion may be easily differentiated from movement associated with an exercise.

The pin units 202a, 302a described above may have a T shape. If the electronics, or more particularly the ultrasonic transmitter, receiver, or transducer is located in the arms of the T, the distance from the transmitter, receiver, or transducer to the floor unit may vary based on a rotation of the pin unit and as such the distance measurements may vary. In order to account for the varying distance, the rotation of the pin unit may be determined using accelerometers and/or gyroscopes in the T shape and the orientation accounted for in the distance calculation. Alternatively, the transmitter, receiver, or transducer may be located on a centerline of the pin unit, which may have a circular or rounded shape handle, so that the distance to the floor unit does not vary even if the pin unit is rotated.

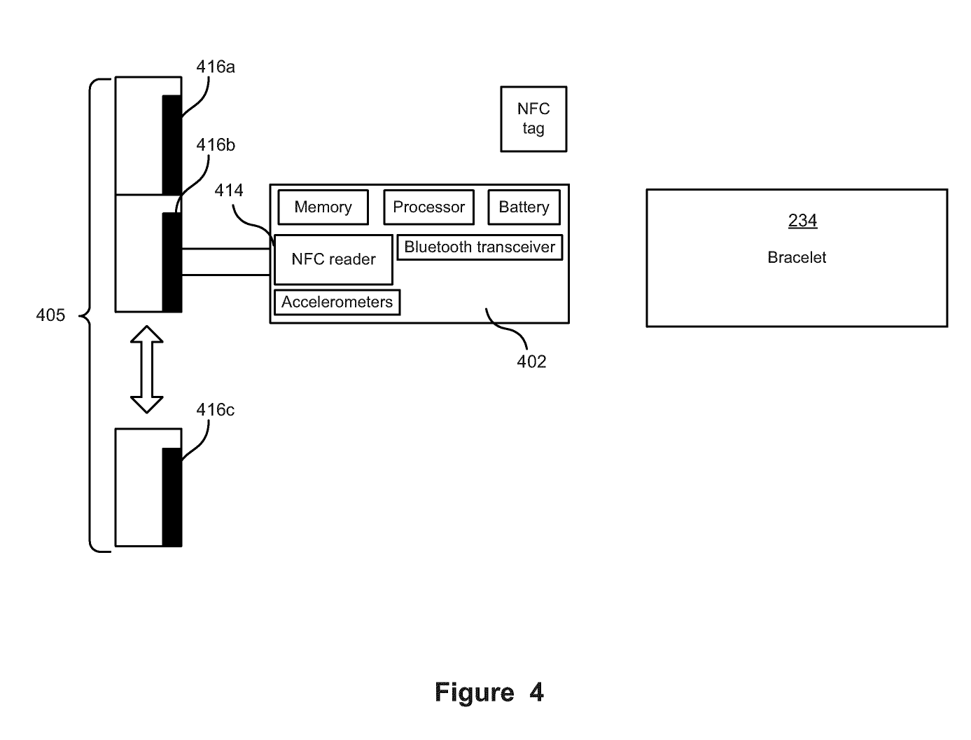

FIG. 4 depicts further components for tracking workout related information on a selectable weight plate machine. The weight stack selector device 402 is substantially similar to the weight stack selector devices 202, 302 with regard to functionality. Accordingly, similar components between the devices, which are not labelled in FIG. 4, are not described in further detail and only the differences between the devices are described. The weight stack selector devices 202, 302 described above may include a floor unit and a pin unit. In order to determine a weight associated with an exercise, as well as other workout related information such as repetition counts, tempo etc, a range finding device is used to determine a distance between the two units. In contrast, the weight stack selector device 402 comprises a single pin unit that determines a weight selected using an NFC tag reader 414. The NFC tag reader is positioned such that when the pin is inserted into a weight plate 405, the NFC reader is able to read an NFC tag 416a, 416b, 416c that uniquely identifies the associated weight stack. Accordingly, the pin unit is able to identify the selected weight plate and determine the associated weight.

In contrast to the weight stack selector devices 202, 302 described above, which used distance measurements to determine workout related information, such as repetition counts, tempo etc, the weight stack selector device 402 may use the accelerometers of the device to determine velocity information, which may be used to determine the workout related information as described above.

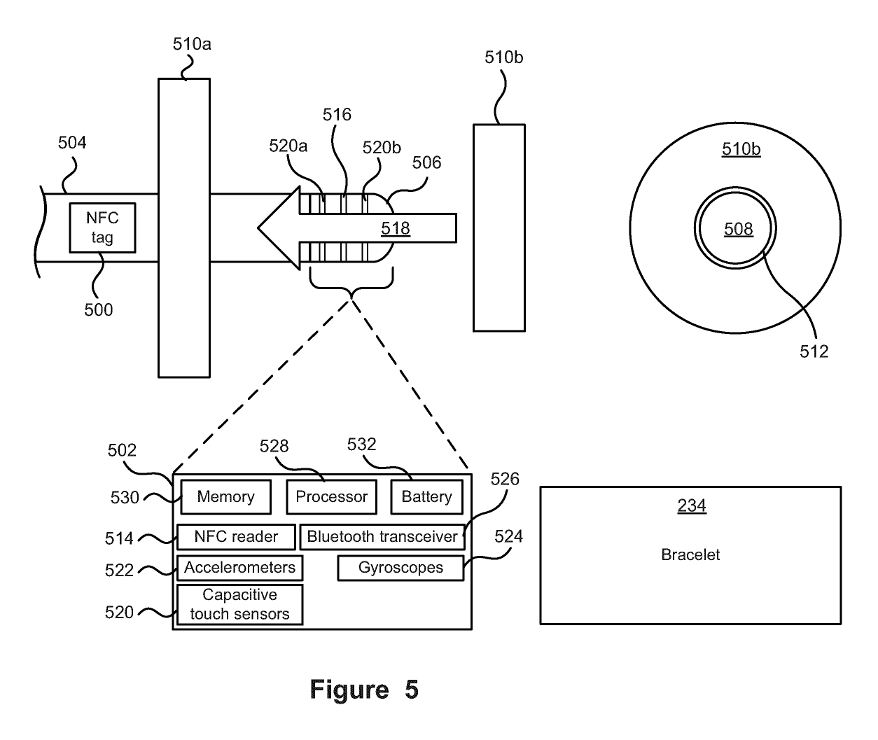

FIG. 5 depicts components for tracking workout related information on a removable weight plate machine. A removable plate device 502 provides similar functionality to the weight stack selector devices 202, 302, 402 described above, and as such similar functionality between the two devices is not described in further detail. As will be appreciated, the technique used by the weight stack selector devices 202, 302, 402 would not function with a removable weight type device such as a barbell or free weights.

In order to be able to determine an amount of weight associated with an exercise, each removable weight receiving bar 504 may be associated with a removable plate device 502. The removable plate device is able to determine weight plates that are being added to or removed from the bar 504 and as such are able to track an amount of weight used for an exercise. The removable plate device 502 may be removably secured to an end of the bar 504, for example using a screw-in base that is secured to the bar with adhesive or fasteners. The removable plate device 502 includes a housing 506 that is sized to fit through the openings 508 of the removable weight plates 510a, 510b (referred to collectively as removable weight plates 510).

Each of the removable weight plates 510 may have Near Field Communication (NFC) tags 512, which may be located within the openings 508 of the weight plates 510. The NFC tag may be read by an NFC reader 514 of the removable plate device 502. The removable weight plate device 502 may be provided with an external antenna 516 for the NFC reader 514 in order to increase the success rate of reading the NFC tag 512 as the weight plates 510 are added and/or removed. As the weight plates slide past the removable plate device, depicted by arrow 518, the NFC reader 514 may read the NFC tags 508 on the weight plates.

In order to determine whether a weight plate is being added or removed the removable plate device 502 may include capacitive touch sensors 520 with appropriate touch sensitive surfaces 520a, 520b spaced apart from each other on the housing of the removable plate device 502. If the outboard capacitive touch sensor 520b is activated first, then the removable plate device 502 may determine that that particular weight plate is being added to the weight. If, instead, the inboard capacitive touch sensor 520a is activated first, then the removable plate device 502 may determine that that particular weight plate is being removed from the removable plate device 502. It is contemplated that other proximity sensors (such as IR sensors) could be used to determine whether a weight plate has been added to or removed from the removable plate device 502.

The removable plate device 502 device may further include one or more accelerometers 522 and/or one or more gyroscopes 524 for detecting movement of the equipment. It is contemplated that the accelerometers and gyroscopes of the bracelet 234 may be used in addition to, or instead of, the accelerometers and gyroscopes of the removable plate device 502. Regardless of which accelerometer and or gyroscopes are used, data provided by the accelerometer(s) and/or gyroscope(s) may be used to count repetitions. The weight information, and if determined at the removable plate device 502 the repetition information, may be communicated to the bracelet 234 using a wireless communication interface, such as a Bluetooth or Bluetooth low energy modules 526 of the removable plate device 502.

The removable plate device 502 may further include a processor or microcontroller 528 and associated memory 530 and battery 532. The processor or microcontroller 528 executes instructions stored in the memory 530 in order to provide functionality described herein.

When a capacitive touch sensor 520a, 520b detects a weight plate 510, it places the removable plate device 502, which is otherwise in a sleep mode, in an awake mode and activates the NFC reader. The NFC reader reads the NFC tag 512 on the weight plate as it passes over the reader antenna 516. The removable plate device 502 may then add or remove the amount of weight indicated by the NFC tag to the current weight associated with the removable plate device 502. As described above, whether or not the weight is being added or removed may be determined based on which contact sensor 520a, 520b was activated prior to the NFC tag 512 being read by the NFC reader.

The removable plate device 502 may be mounted onto only one of the ends of each of the bars, and the weight determined based on the assumption that both ends of the bar 504 will have the same amount of weight placed on it. However, it is contemplated that a single bar could include the removable plate device 502 mounted onto both ends.

Although described above as using capacitive touch sensors 520 to determine in which direction a weight plate is being slid, it is contemplated that other sensors may be used to provide similar functionality. For example two IR proximity sensors or two contact sensors or switches could be used.

Although described above as being provided by an NFC tag and NFC reader, it is contemplated that the removable plate device 502 could instead use a barcode scanner to read barcode stickers on the weight plates. Further, RFID tags and RFID readers or BLE tags and radios could be used in place of the NFC tags and readers.

Additionally or alternatively, color codings on weight plates and a color sensor may be used to determine a weight of the plate being added or removed. One color may be associated with each plate weight, such as 5 lbs, 10 lbs, etc. A sticker or paint of each color may then be stuck onto the opening of each weight plate 510, so that it can be read by the color sensor in the removable plate device 502. For example, red stickers may be placed in the inner circle of all 5 lb weight plates, blue stickers may be placed in the inner circle of all 10 lb plates, etc. When any given weight plate is slid onto, or off of, a bar, it slides past the removable plate device 502, and the color sensor in the removable plate device 502 reads the color of the plate. When, for example, the color sensor detects red, it knows that the weight plate that just slid by is a 5 lb weight plate.

It is contemplated that additional techniques may be used to determine an amount of weight associated with an exercise using free weights. For example, the weight on any bar could be detected using a sensor using a load cell or force sensitive resistor or pressure sensor placed onto a squat rack, bench press rack, or preacher curl rack, or other barbell racks used in fitness facilities. The load cell or force sensitive resistor or pressure sensor may use adhesive to install onto any metallic or plastic surface of the rack equipment. The load cell or force sensitive resistor or pressure sensor may also be inserted into a pad or floor mat, so that when a barbell is placed on the pad(s) or floor mat(s), the load cell or force sensitive resistor or pressure sensor would detect how much weight is on the mat or mats and so the barbell. The load cell or force sensitive resistor or pressure sensor may register the load on any barbell placed on any of these surfaces and would transfer the information using Bluetooth Low Energy, or another form of communication, such as RF. The load cell or force sensitive resistor or pressure sensor could also be embedded into the bar itself, and would register the load on the bar at any time.

As described above, the removable plate device 502 may be mounted onto to an end of a bar that receives removable weight plates. The removable plate device 502 is able to track the amount of weight currently on the bar and communicate the workout related information to an associated bracelet, that may be associated with the equipment by way of an NFC tag 534 present on the bar 504 and/or on the removable plate device 502. It is possible to associate the equipment with a bracelet in other ways. For example, both the equipment and the bracelet may transmit movement information to a computer system that can compare movement information from equipment devices to the movement information of bracelets in order to locate equipment devices and bracelets that have matching movement information. Additionally or alternatively, the association between a piece of equipment and a user may be determined based on signal strengths of radios. For example, a bracelet of a user may determine an associated piece of equipment based on the signal strengths from equipment devices of the equipment in the vicinity. In particular, the highest signal strength may be assumed to be from the equipment device being used by the user. Further still, it may be possible to associate a user with a piece of equipment based on a physical location of the user and the piece of equipment. The position of both the pieces of equipment and users may be determined in various ways such using signal strengths from wireless transmitters having a known location such as wireless transmissions from equipment devices located on stationary equipment, or possibly on wireless transmitters placed at known locations. Regardless of how the location of the equipment and user is determined the respective locations may be communicated to computing device and compared in order to determine associations of users and equipment.

The removable plate device 502 may also track repetition information, for example using accelerometers 522 and gyroscopes 524 and communicate the workout related information to the bracelet. Additionally or alternatively, the workout related information for determining the repetition counts may be provided by the accelerometers and/or gyroscopes of the bracelet.

The above has described various ways of associating a removable plate device with a user, or more particularly a user's bracelet or other device associated with the user. Similar techniques may be used to associate a user with other pieces of equipment, such as a selectable weight machine. For selectable weight plate machines, the association may be based on a comparison of a user's motion determined for example from the user's bracelet to a known or assumed range of motion associated with one or more exercises that can be performed on the selectable weight plate device. For example, when in use, the selectable weight plate machine may broadcast information indicative of its use such as a repetition count and weight used. User's bracelets may also broadcast, or transmit on an established communication channel, information such as an identifier and movement information. The information from equipment devices and bracelets may be received at a computing device and when a selectable weight plate machine is in use, as indicated by the repetition information, the expected movement associated with the machine can be compared to the bracelet movement of users in order to match a bracelet's movement to the machine. Further, the association between a selectable weight machine and a user may be based on a known, or determined, location of the selectable weight machine in comparison to determined locations of user's or may be based on a signal strength of received signals from equipment devices.

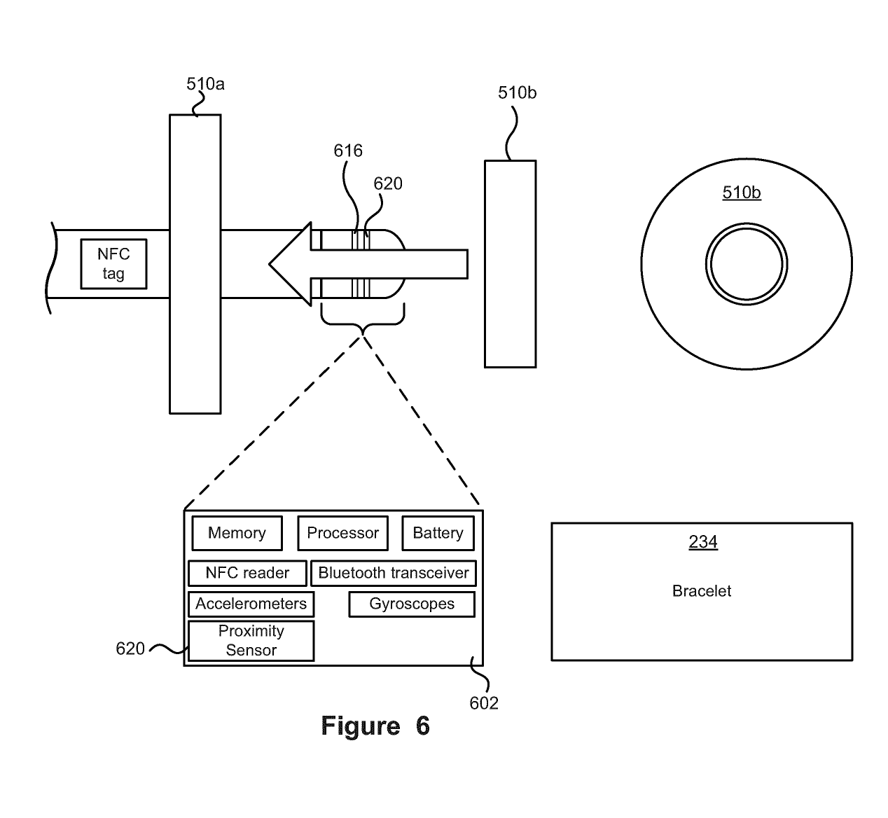

FIG. 6 depicts further components for tracking workout related information on a removable weight plate machine. The removable plate device 602 is similar in functionality to the removable plate device 502 described above. Both removable plate devices 502, 602 read, or detect, an identifier associated with a weight plate when it is added or removed from a bar and updates a weight associated with the bar accordingly. As described above, the removable plate device 502 uses two sensors to determine whether a weight plate is being added or removed. In contrast the removable plate device 602 does not use sensors to determine if the weight plates 510a, 510b are being added or removed. Instead, the removable plate device 602 reads the NFC tag associated with the weight plate and compares the ID used to identify the particular plate with those plates already on the bar. If the identified plate is determined to already be on the bar, than the plate is being removed and the weight is adjusted accordingly. If the identified plate is determined to not be on the bar, than the plate is being added and the weight is adjusted accordingly.

In order to increase battery operating time of the removable plate device 602, a proximity sensor 620 may be used to detect the proximity of a weight plate and turn on the NFC reader only when a weight plate is detected to be in proximity. The proximity sensor may be a metal detection circuit that is tuned to detect the weight plates when they are within a few, for example 1-5 cm, of the sensor. Other detection distances may be used. When a weight plate is detected by the proximity sensor, the NFC reader may begin attempting to read any NFC tags, and as the weight plate with associated NFC tag is slid past the NFC reader or more particularly the NFC antenna 616, the tag is read. The NFC tag may specify the weight of the plate or may provide an identifier used to determine the weight of the plate.

Although not depicted in the Figures, the removable plate devices 502, 602 may include auditory and/or visual feedback to provide indications as to when weight is added or removed from a bar. In order to account for a weight of a bar, the removable plate devices 502, 602 may be provided with a bar weight when they are associated with the bar. Additionally or alternatively, the bar may include an NFC tag that is used, for example by a user's bracelet 234 to identify the bar and determine the weight.

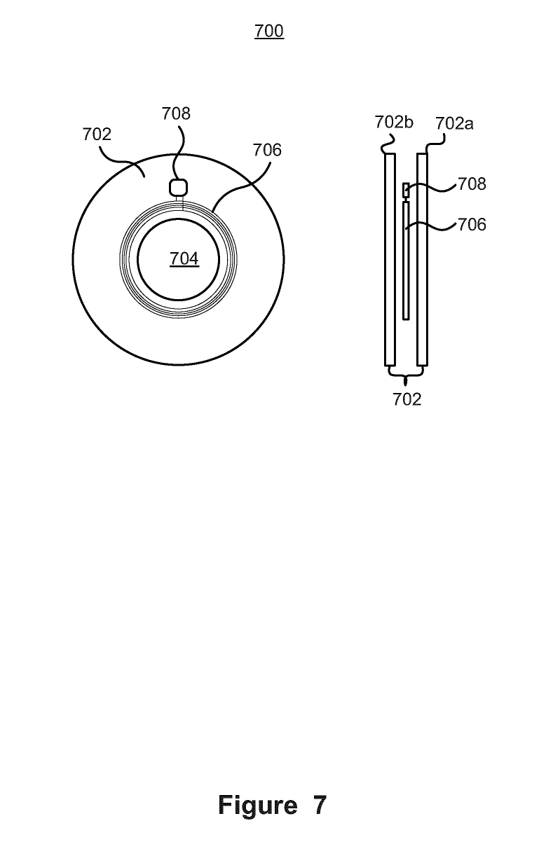

FIG. 7 depicts components of an NFC tag for use with removable weight plates. The NFC tag 700 comprises a body 702 that encases an inductive antenna or wire loop 706. The loop 706 is depicted as a series of concentric circles for simplicity; however, it will be appreciated that the loop is provided as a single wire that is wound a number of times. Each end of the wire is connected to an NFC chip or circuit 708 that can provide an ID, or other information, when the tag is read. The wire loop 706 is wound about an opening 704 in the body 702. The opening 704 is aligned with an opening in the weight plate through which a bar is inserted. The body 702 may comprise an anti-metal backing 702a that is adhered to the weight plate. The anti-metal backing improves the read success of the NFC tag when it is affixed to the weight plate. A covering 702b covers the wire loop 706 and chip 708 and seals the NFC tag.

The NFC tag 700 may be placed on one side of a weight plate and read by an NFC reader as the reader passes through the opening 704 and through the center of the wire loop 706. In order to increase the read success rate, NFC tags 700 may be placed on each side of the weight plate. Further, although described as being used with removable weight plates, a similar NFC tag structure could be used with a selectable weight plate machine, such as the embodiment described above with reference to FIG. 4. The opening would allow the selector pin to pass through the wire loop and identify the selected weight.

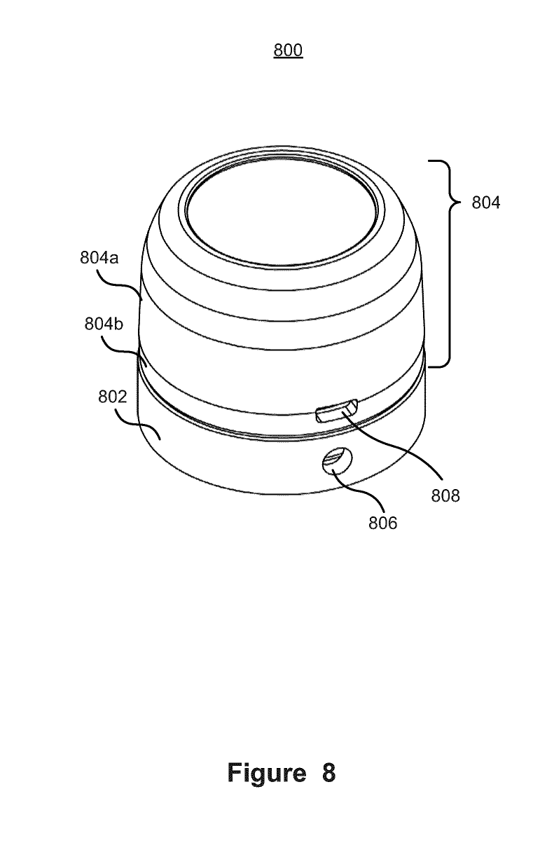

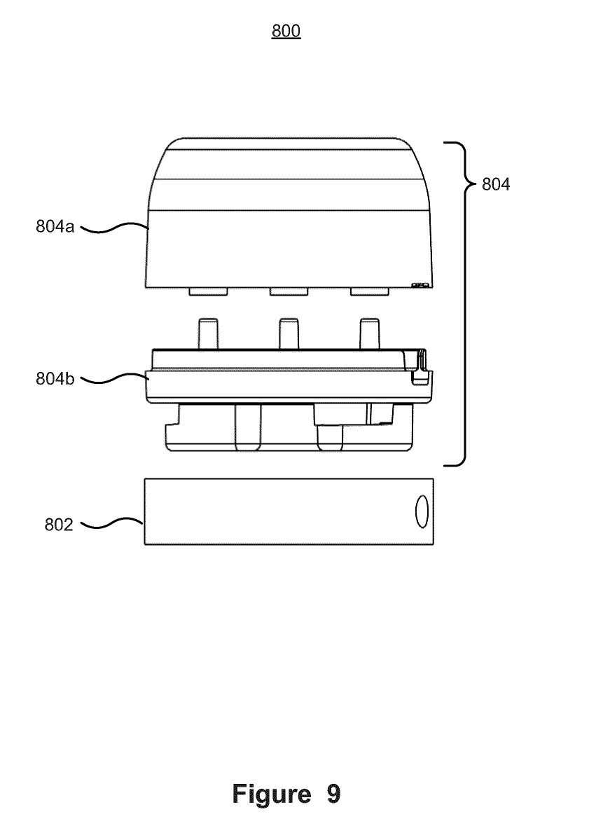

FIG. 8 depicts a schematic of a housing fixture for a removable plate device. FIG. 9 depicts an exploded schematic of the housing fixture of FIG. 8. The housing fixture 800 may enclose electronics as described above with reference to FIGS. 5 and 6. The housing fixture 800 comprises a base 802 that can be adhered or affixed to the end of a bar. The base 802 may be made from metal or other resilient materials. The base 802 may be secured to the bar using an adhesive and/or mechanical devices such as screws. Further, it may be possible to secure the base 802 using a magnet or magnets. The base 802 is permanently, or semi-permanently attached to the bar. The housing fixture 800 further comprises a housing 804 that houses the electronics and can be removably secured to the base 802. The housing 804 may be made from two pieces in order to allow the electronics to be inserted, while still protecting the electronics from the environment. The housing 804 may comprise an upper housing 804a and a lower housing 804b that can be secured together, for example using a friction fit, snap fit, screws or other types of connections. Once assembled, the housing 804 may be secured to the base for example using a twist-lock type connection, or other types of connections. The base 802 may comprise a screw hole 806 for receiving a screw that can be secured to prevent the housing 804 from being removed. The housing 804 may also include an opening 808 that can be used for charging the removable plate device and/or establishing a wired connection with the electronics. The housing fixture 800 is sized so that it will fit through an opening in a weight plate.

The housing fixture 800 should be sufficiently strong to prevent or resist damage during use. Barbells may be dropped on the ends with sufficient force to possibly cause damage. The housing 804 may be further strengthened by using stronger materials or thicker walls or other design considerations used to provide additional strength. Additionally, or alternatively, the strength of the housing may be increased by filling an interior void of the housing with a material to provide a solid interior volume in the housing 804.

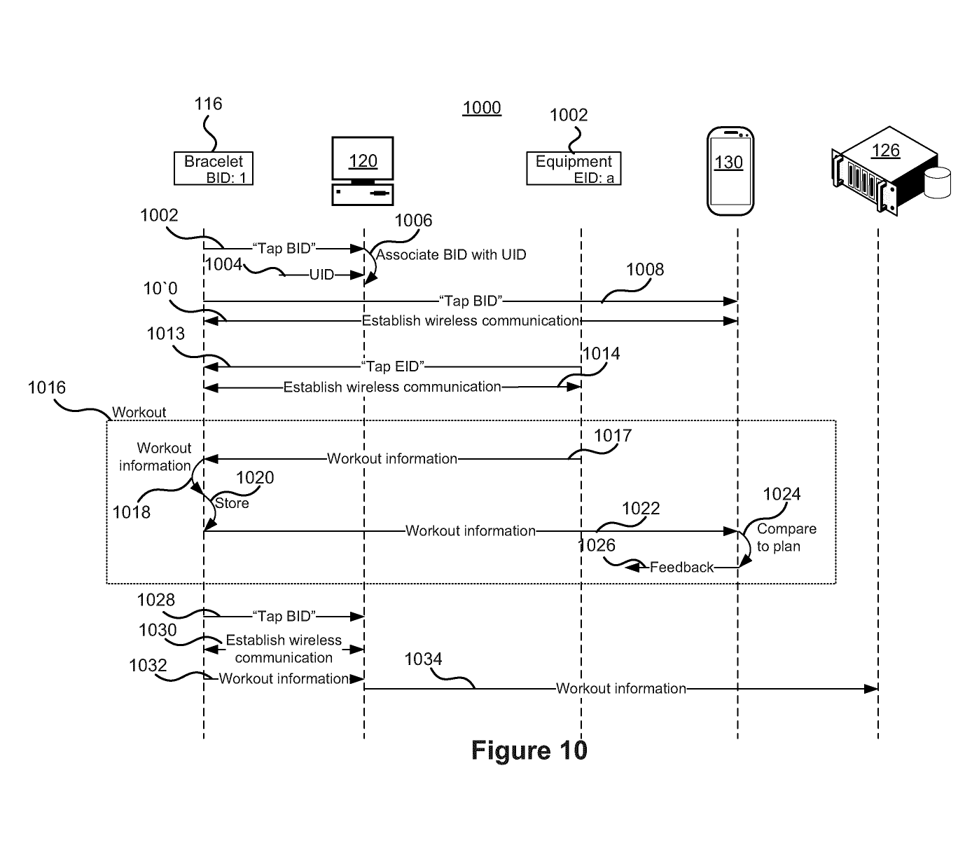

FIG. 10 depicts a process flow of the system for tracking workout related information. The process 1000 depicts the interaction between the bracelet device 116, which is assumed to have a unique bracelet identifier of BID:1, the computing device 120, a piece of workout equipment 1002 associated with a unique equipment identifier of EID:a, a user's portable device 130 and the networked computing device 126. The piece of workout equipment 1002 may be any piece of workout equipment capable of communicating workout related information, including an amount of weight being used, to the bracelet 106. The workout related information communicated by the piece of workout equipment may include information indicative of a number of repetitions of an exercise. Additionally or alternatively, the workout related information indicative of the number of repetitions may be provided by the bracelet 106.

The process 1000 begins with the bracelet 116 being associated with a user that will be using the bracelet for their workout. For example, the bracelet may be tapped 1002 to a reader associated with the computing device in order to read the bracelet ID of the bracelet. The computing device 120 may also receive a user ID 1004, which may be provided in various ways, such as manually selected a user, or tapping a user's ID token or pass to an appropriate reader associated with the computing device. The computing device 120 may then associate the bracelet ID with the user 1006.

Additionally, or alternatively, the bracelet 116 may be associated with a portable device 130 of the user. The bracelet may again be tapped 1008 to the user's portable device 130 in order to communicate the bracelet ID to the portable device. In the process 1000, it is assumed that the portable device 130 is the personal device of the user, and as such a user ID is already available at the portable device 130 and so does not need to be provided. The portable device 130 and the bracelet may establish a wireless communication path 1010, for example using Bluetooth or Bluetooth low Energy communication technologies.

When the user begins their workout, the read an equipment ID associated with the piece of equipment they will be using 1012. The bracelet then establishes wireless communication 1014 with the weight monitoring device associated with the piece of equipment. Although described as establishing a wireless communication channel between the bracelet and the equipment, it is possible for the bracelet to use the equipment ID in order to identify workout related information broadcast on an open channel. For example, Bluetooth Low Energy (BLE) provides an advertising beacon that allows data to be broadcast from the BLE radio. The BLE radio may broadcast the workout related information and the associated equipment ID. The bracelet may use the equipment ID to identify the correct workout related information associated with the equipment being used from among other broadcast workout related information. The user may then begin their workout exercise 1016, during which workout related information is communicated from the weight monitoring device of the piece of equipment 1017. Additional workout related information may be provided 1018 by the bracelet, such as data from accelerometers and/or gyroscopes of the bracelet 116. The bracelet stores 1020 the workout related information. If the bracelet is connected to a portable device, it may also communicate 1022 the workout related information to the portable device 130 in real-time or near real-time. The portable device may process the workout related information, including comparing 1024 the workout related information to a workout plan being performed by the user. Based on the processing of the workout related information, the portable device may provide feedback 1026 to the user. The feedback may be provided in a variety of different ways. For example, the feedback may provide an indication of a number of repetitions or time remaining for the current exercise, may provide motivational feedback for encouraging the user, either as verbal feedback or for example by altering characteristics of workout music the user is listening to. The feedback may also provide instructions for correcting or improving techniques, as well as a next exercise to be performed according to the workout plan.

The user may switch to another piece of equipment during their workout, and the process from 1012 to 1026 may be repeated at the new piece of equipment.

Once the user's workout is completed, the bracelet may be returned. The return process may include checking the bracelet in at the computing device 120. The check in may be accomplished by tapping 1028 the bracelet on an appropriate reader that determines the bracelet ID of the bracelet. Wireless communication may be established 1030 between the bracelet and the computing device 130 and used to transfer the stored workout related information to the computing device 120. The computing device 120 may transmit the workout related information to the networked computing device 126. The networked computing device 126 may store the workout related information for subsequent access by the user, or other authorized people, such as gym owners, operators, managers, and/or personal trainers.

The equipment device is depicted in FIG. 10 as communicating the workout related information directly to the bracelet, which in turn communicates the workout information to another device. It is possible for the equipment device to receive a user identifier from the bracelet and to transmit the workout information and received user identifier to the other device directly without having to communicate with the bracelet. The other device may be a computing device of the user such as a smart phone or may be a computing device of the gym facility such as the networked computing device 126. If the bracelet or wearable device does not store workout related information, it may be possible for the bracelet to be a passive device, that is a device without sensors for tracking movement, such as a NFC or BLE tag. In such scenarios, the equipment device may include sensors for determining workout information including for example repetition information which may be communicated in association with the user ID to a computing device for further processing.

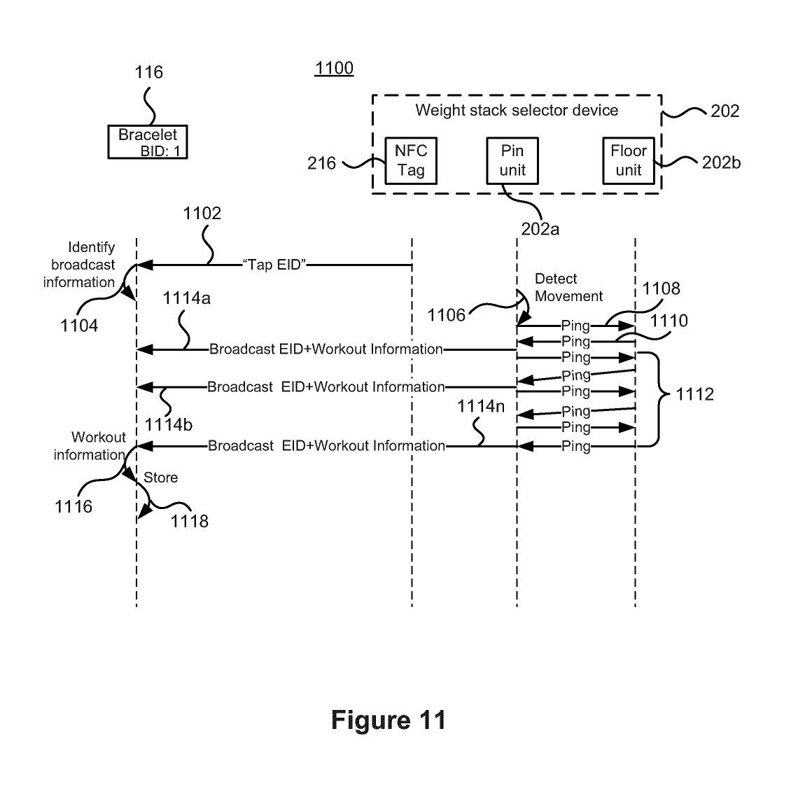

FIG. 11 depicts a process flow for tracking workout related information on a selectable weight plate machine. The process 1100 begins when a user taps 1102 an NFC tag 216 of the selectable weight plate machine, which may be placed on the machine itself, a selector pin unit 202a of the weight stack selector device 202, or in the immediate vicinity of the machine. The unique equipment ID (EID) of the equipment is received by the bracelet 116 and used to identify or determine broadcast information 1104 that will be used by the equipment when broadcasting the workout related information. The identified broadcast information allows the bracelet to identify the correct broadcasted workout related information when multiple different pieces of equipment are broadcasting workout related information. As described above with reference to FIG. 10, it is possible for the bracelet to establish a communication channel with the equipment instead of broadcasting information. Broadcasting workout related may allow a shorter setup time since no communication channel needs to be established. Further, by monitoring the broadcast information it is possible to determine which equipment is currently being used, and so also which equipment is not currently in use.

Before or after tapping the NFC tag, the user may move the selector pin unit 202a to select the desired weight stack for the exercise. The pin selector unit 202 detects the movement 1108, and begins transmitting 1108 ‘Ping’ signals to the floor unit 202b. The ‘Pings’ may be IR pings as described with regard to FIG. 2 or may be ultrasonic ‘Pings’ as described with reference to FIG. 3. When the floor unit 202b detects a Ping signal it wakes up and causes an ultrasonic ping 1110 to be sent to the selector pin unit. The subsequent to receiving the ping, the selector pin unit 202a periodically sends repeated Ping signals to the floor unit, which cause the floor unit to respond with a corresponding Ping 1112. Based on time differences between when a Ping was transmitted and when the corresponding Ping was received at the selector pin unit 202a, workout related information may be determined, including a selected weight plate used for the exercise as well a number of repetitions performed. The workout related information, along with the EID, is periodically broadcast 1114a, 1114b, 1114c using for example on a BLE advertising channel. The bracelet receives the broadcast workout related information identified with the EID. The bracelet may provide 1116 additional workout related information, such as orientation of the bracelet, which may be indicative of a particular grip used on the machine. The bracelet may then store the workout related information. The communication of the workout related information may continue until the exercise has been completed.

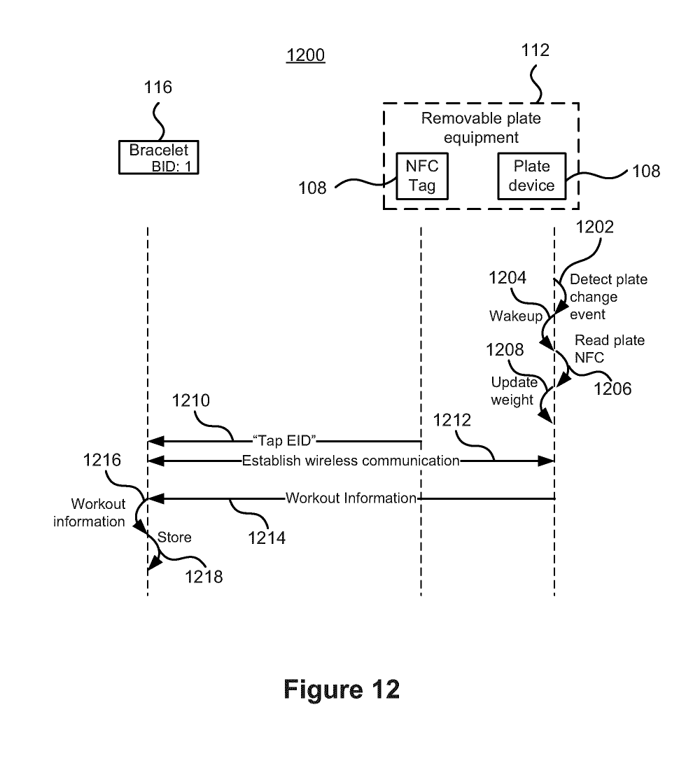

FIG. 12 depicts a process flow for tracking workout related information on a removable weight plate machine. The process 1200 begins when a removable plate device 108 detects a plate change event 1202, which may be provided by, for example one of two touch sensitive sensors 520a, 520b, or by detecting the proximity of the weight plate using a proximity sensor 620. Upon detecting the plate change event, the removable plate device 108 wakes up 1204 and causes the NFC reader of the removable plate device 108 to read an NFC tag of the removable weight plate being changed. Once the plate NFC is read, the removable plate device 108 updates an associated weight by adding or removing the weight associated with the plate NFC tag. Whether a weight should be added or removed may be based on which one of two contact sensors 520a, 520b was activated prior to reading the NFC tag. If an inboard sensor 520a, that is the sensor closest to the bar, was activated first, the weight is being removed. If an outboard sensor 520b, that is the sensor furthest from the bar, was activated first, the weight is being added. Additionally or alternative, whether the weight should be added or removed may be based on whether an ID of the read NFC tag is already associated with the bar. If the weight plate is already associated with the bar, it may be assumed that the plate is being removed from the bar and the weight adjusted accordingly. When removing a weight, the ID read from the NFC tag associated with the weight plate may be removed from a list of associated weight plates, or otherwise marked as no longer associated with the bar. If the ID read from the NFC tag is not associated with the bar already, for example it is not in a list of weight plates that have been added to the bar, it may be assumed that the weight plate is being added and the weight, as well as list of associated weight plates, updated accordingly.

The process 1200 includes the user tapping 1210 their bracelet 116 to determine the unique equipment ID, which may be read from, for example an NFC tag 114 associated with the piece of equipment, or the removable plate device 108 associated with the equipment. The bracelet 116 and the removable plate device 108, depicted as barbell unit for brevity in FIG. 6, establish a wireless communication channel 1212. As described above, rather than establishing a wireless communication channel to transfer workout related information over, the removable plate device 108 may broadcast the workout related information in association with the EID to allow the bracelet to identify the correct broadcast workout related information The removable plate device 108 communicates 1214 workout related information, which may include a weight amount being used for the exercise, and possibly information indicative of repetitions, which may be provided by accelerometers and/or gyroscopes of the removable plate device 108 if present. The bracelet 116 may also provide 1216 workout related information, including information indicative of the number of repetitions, which may be provided by accelerometers and/or gyroscopes of the bracelet. The workout related information may be stored 1218 by the bracelet 116.

Although the above has described various components of a workout related information tracking system, the system may include further components that may be used to provide additional or auxiliary information.

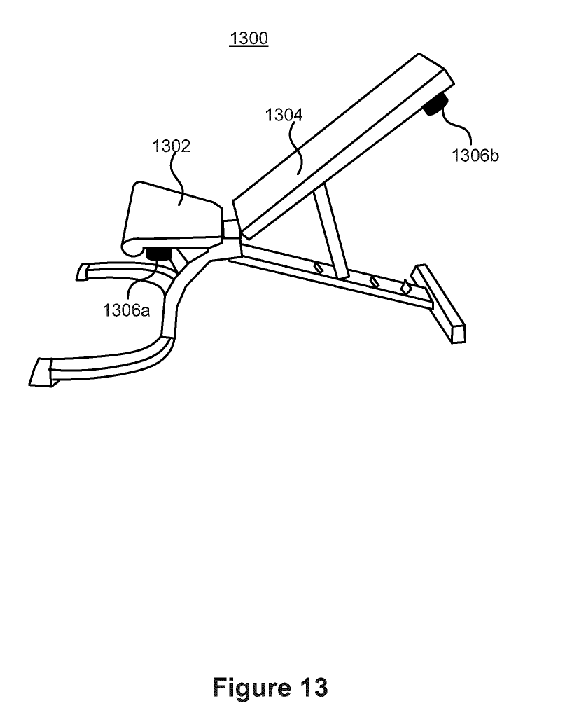

FIG. 13 depicts auxiliary components for use with pieces of auxiliary workout equipment. The auxiliary workout equipment comprises a workout bench 1300 that may include a number of adjustable tiltable portions, such as seat portion 1302 and back portion 1304. Each adjustable portion may be associated with an auxiliary device 1306a, 1306b (referred to collectively as auxiliary devices 1306) that is capable of detecting an inclination of the respective portion. The auxiliary devices 1306 are similar to, for example, the removable plate device 108, in that they provide workout related information. However, the information provided by the auxiliary devices relates to an orientation of the piece of equipment. The auxiliary devices 1306 may communicate with a bracelet in order to communicate the orientation of the equipment. The auxiliary devices 1306 may include one or more sensors, such as accelerometers and gyroscopes for determining the orientation of the equipment. The workout related information provided by the auxiliary devices 1306 may be useful in providing further detailed information regarding a user's workout.

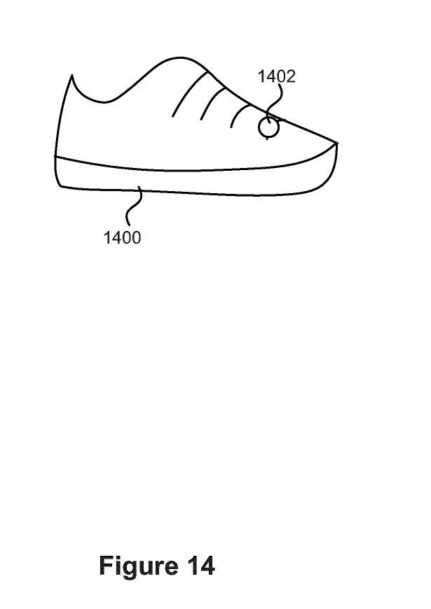

In addition to the auxiliary devices 1306 described above, the system may further devices in addition to, or as alternative to, the bracelet described above. For example an additional bracelet may be worn by the user in order to track movement of both arms. Further a shoe sensor device 1402, depicted in FIG. 14, with similar functionality to the bracelet 116 may be provided. The shoe sensor device 1402 may be provided on or in one or both shoes 1400. The additional shoe sensor may be used in place of the bracelet, especially in systems that provide the removable plate device 108 with accelerometers and gyroscopes for determining repetition counts, since no, or little, functionality will be lost by not being able to track the hand and/or arm movement without the bracelets. Further, the shoe sensor device 1402 may be provided in addition to the bracelet, and may provide additional information, including for example a number of steps taken, as well as impact related information.

In the system described above, each of the devices including the bracelets 116, 118, the removable plate devices 108, the selectable weight plate devices 104, the auxiliary devices 1306 and the shoe sensor devices 1402 may co-operate with one or more other of the devices in order to track workout related information. An NFC reader may used to read NFC tags placed on different pieces of equipment in the fitness facility, such as, but not limited to, attachments for cable machines, free weights, weight stack machines, bench presses, etc. The NFC readers/tags are used so that the system knows exactly which piece of equipment the user is using. The devices cooperate to provide workout related data including information regarding the weight used for an exercise and the number of repetitions performed. In one or more of the devices, gyroscope(s) and accelerometer(s) may used in combination in order to determine, as precisely as possible, which movement the user is performing, and to count the number of repetitions performed. In order to determine which movement the user is performing, and count the number of repetitions performed, the system may take in gyroscope and accelerometer data from one of the devices, such as the bracelet, and compares it to a database of previously stored gyroscope and accelerometer data. Each set of gyroscope and accelerometer data is linked to a certain exercise: for example, bicep curls may be linked to gyroscope data X and accelerometer data Y, whereas shoulder press is linked to gyroscope data Z and accelerometer data A. If, when the user is performing a given exercise, the system detects gyroscope data X and accelerometer data Y, it then refers to the database and determines that the user is currently performing, for example bicep curls. The system may then continue to collect data and determine how many repetitions of that movement the user has performed.

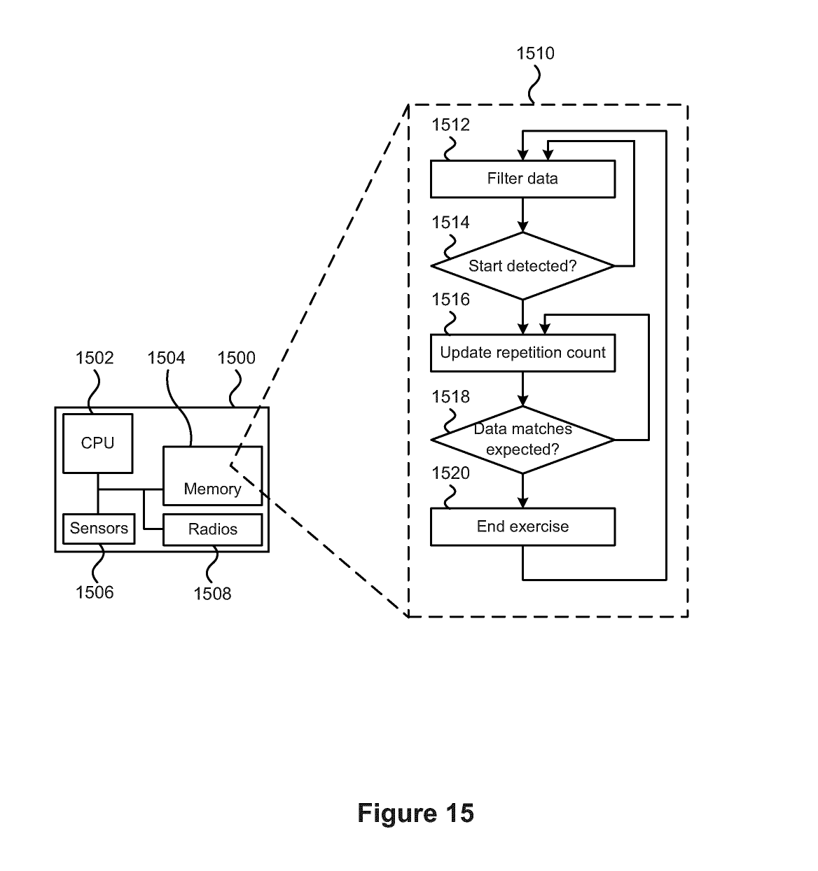

FIG. 15 depicts a wearable device for determining exercise information. The wearable device 1500 may be used as, for example, the bracelet 116 described above and may include a processor 1502 for executing instructions. Data and instructions may be stored in memory 1504 which may include non-volatile memory as well random access memory (RAM) registers and cache of the processor 1502 and other volatile memory storage devices. The portable device may include one or more sensors 1506, including for example, accelerometers, gyroscopes, a heartbeat reader, an oxygen sensor, light sensor, image capture devices, magnetometers, barometers, as well as a wide range of other sensors. The portable device may include one or more wireless interface radios 1508 including wireless radios for cellular communication, wireless radios for wireless local area network connections, such as a Wi-Fi radio, as well as short range wireless communication, such as Bluetooth, and/or Bluetooth Low Energy radios, as well as NFC and/or RFID readers. The wearable device 1500 may further include one or more input/output devices (not depicted), which may be connected to the processor 1502, either directly or through one or more buses connected to the processor. Connected I/O devices may include, for example a touch sensitive display screen, speaker(s) as well as a microphone and other I/O devices.

The data and instructions stored in memory 1504, when executed by the processor 1502, configure the wearable device to provide functionality 1510 for determining exercise information from sensor data. In particular, the functionality 1510 determines, or attempts to determine, when a particular exercise starts and stops and the number of repetitions in between. The functionality uses data from one or more of the sensors, and may include for example the output from accelerometers and gyroscopes. Although not depicted in FIG. 15, the functionality may utilize additional information such as an indication of an expected exercise to be performed as may be provided based on proximity to equipment, or a workout plan available to the functionality.

The functionality 1510 receives data from the sensors, and in particular from the accelerometers and gyroscopes, each of which may provide 3 channels of data namely x, y, z motion and pitch, yaw, roll motion. The data is initially filtered (1512) or pre-processed to remove data that is easily identifiable as not associated with an exercise. For example, random motion on the 6 different channels may be discarded. By initially filtering the data, less data may be processed when attempting to determine if the data is associated with a start of an exercise. The filtering has a high false positive rate, that is data that is not in fact associated with an exercise may not be filtered out. The filtering may act as a trigger for further processing. That is data that passes through the filter may trigger further processing by the functionality 1510. The further processing includes attempting to determine if the motion, or rather the sensor data of the motion, corresponds to start motion associated with an exercise (1514). The check for detecting a start of an exercise may compare the data from one or more of the data channels with previously trained data of known starts. A score may be calculated for the data that provides an indication of whether or not the data matches expected data. The score may be a value from 0 to 1. The data may be compared to expected data for a number of possible exercises and the exercise with the highest score, above a minimum threshold may be used as the identified start exercise. If no start is detected (No at 1514) the processing returns to pre-processing, or filtering the data (1512). If a start is detected (Yes at 1514), the functionality 1500 begins to track repetitions of the exercise. Periodically, the data is used to update a repetition count (1506) of the exercise. The repetition count may use maximum and minimum, as well as possibly intermediary, velocity information from the data to update the repetition count. When a new repetition is completed the data from the beginning of the repetition may be compared to expected data of the exercise (1518) determine if the exercise has ended. For example, after completing an bicep curl, the movement would differ depending upon whether the user is performing another repetition of the bicep curl, or if the user is putting the weight down. If the data matches the expected data for the exercise (Yes at 1518), the data is processed for updating the repetition count, as well as other workout related information such as the tempo of the exercise. If the data does not match the expected data (No at 1518) the exercise ends (1520), and processing may return to pre-processing or filtering data to detect start of another exercise (1502).

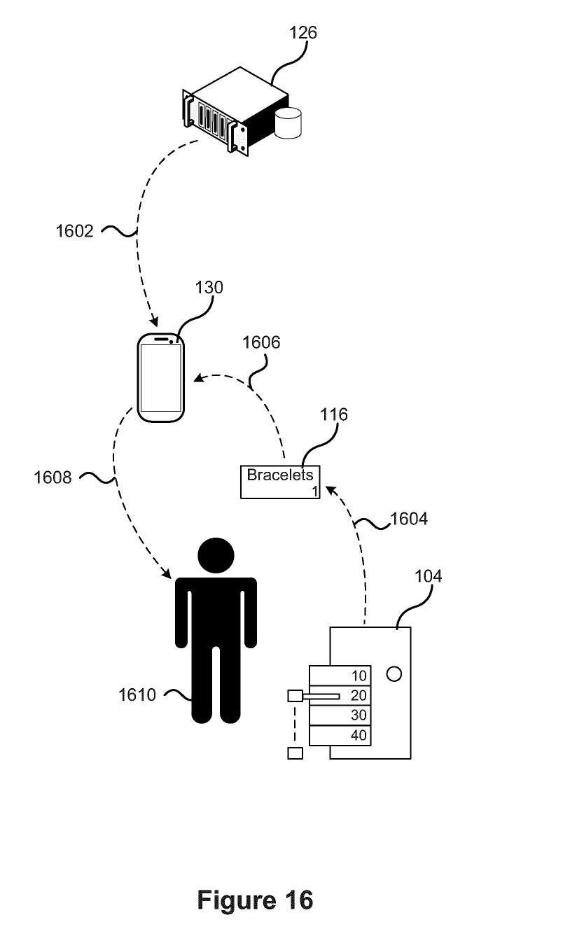

FIG. 16 depicts a process for providing workout instructions using the system for tracking workout related information. As described above, a user 1610 may utilize a portable device 130 while working out. The portable device 130 may be paired with a bracelet 116 as described above. Prior to working out, the user 1610 may download, or otherwise provide, for example by imputing, a work out plan. The workout plan may be downloaded from the networked device 126, and may be prepared by the user 1610, by a personal trainer, or selected from a plurality of available workout plans. The networked computing device 126 may analyze previous workout related information associated with the user and provide recommended workout plans or tailor existing workout plans to the user 1610 based on past performance. Further, the workout plan may be prepared or modified by a qualified trainer based on previous workout related information. Regardless of how the workout plan is prepared, it is loaded onto the portable device 130, depicted by dashed arrow 1602. During the workout, the user's bracelet 116 communicates with the workout equipment 104, or other workout equipment described above. The bracelet receives workout related information from the equipment, depicted by dashed arrow 1604, and may provide the received workout related information and possibly workout related information from the bracelet itself, to the portable device, depicted by dashed arrow 1606. The portable device 130 may receive the workout related information in real-time or near real-time and processes the workout related information. The processing of the workout related information may include, for example, comparing a current exercise being performed to an expected exercise from the workout plan and providing feedback based on the comparison, depicted as dashed arrow 1608. As a simple example, the feedback may provide a countdown until the number of repetitions specified in the workout plan has been achieved. Further feedback may include, for example detecting a slowing pace near an end of an exercise and providing additional motivation to the user, such as providing motivational words to the user, or playing motivating music for the user 1610.

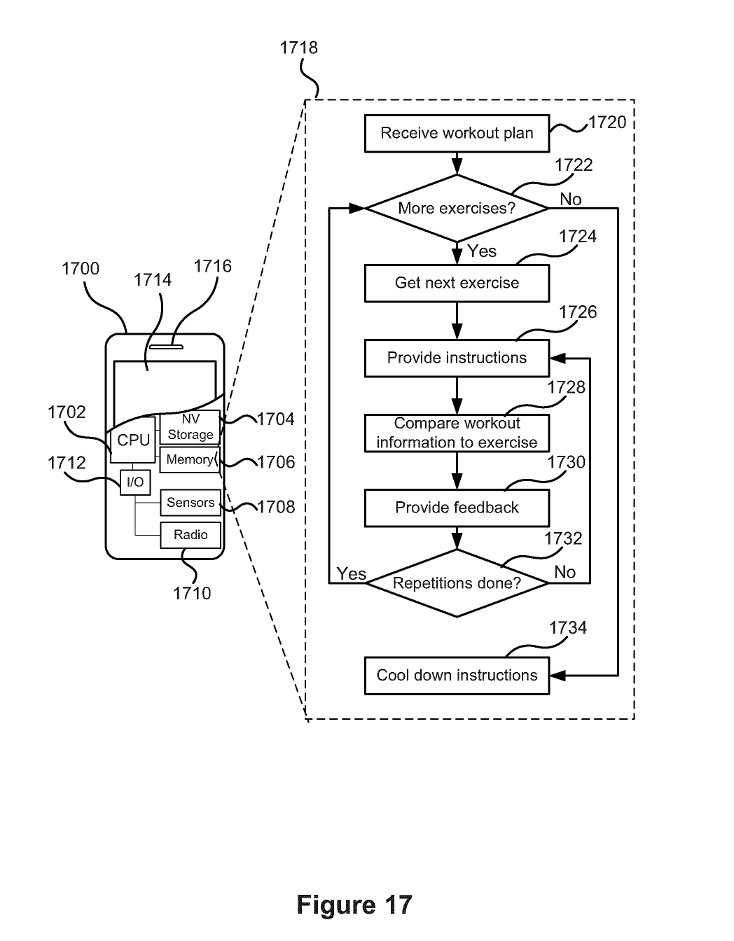

FIG. 17 depicts a device for providing workout instructions using the system for tracking workout related information. The device 1700 may be used as the portable device 130 described above and may include a processor 1702 for executing instructions. Data and instructions may be stored in non-volatile memory 1704, as well as memory 1706 which may include random access memory (RAM) registers and cache of the processor 1702 and other volatile memory storage devices. The portable device may include one or more sensors 1708, including for example, a fingerprint reader, a heartbeat reader, and oxygen sensor, light sensor, accelerometers, gyroscopes, magnetometers, barometers, image capture devices as well as a wide range of other sensors. The portable device may include one or more wireless interfaces 1710 including wireless radios for cellular communication, wireless radios for wireless local area network connections, such as a Wi-Fi radio, as well as short range wireless communication, such as Bluetooth, and/or Bluetooth Low Energy radios, as well as NFC and/or RFID readers. The portable device 1700 may further include one or more input/output devices 1712, which may be connected to the processor 1702, either directly or through one or more buses connected to the processor. Connected I/O devices may include, for example a touch sensitive display screen 1714, speaker(s) 1716 as well as a microphone and other I/O devices.

The data and instructions stored in memory 1706, when executed by the processor 1702, configure the device to provide functionality 17018 for providing workout instructions to a user based on workout related information received from a bracelet (not shown) worn by the user during the workout. Providing workout instructions to the user may include receiving a workout plan (1720) specifying one or more exercises to be performed by the user at a particular piece of equipment and using an associated weight. After starting the workout, the configured portable device 1700 determines if there are more exercises to be performed in the workout plan (1722). If there are more exercises (Yes at 1722), the next exercise is determined (1724) and instructions provided (1726). The provided instructions may be user configurable and may include, for example telling the user the equipment to use, the exercise to perform, an amount of weight to use. The portable device 1700 is further configured to receive and compare workout related information from the bracelet to the exercise information (1728) and based on the comparison provide feedback (1730). The feedback may include motivational or informational feedback based on the comparison. After providing any feedback, it is determined if the repetitions for the exercise or completed (1732) and if they are not (No at 1732), processing returns to compare the workout related information to the exercise information in the workout plan (1728). If the repetitions are completed (Yes at 1732) processing returns to determine if there are more exercises to perform (1722). If there are no more exercises to perform (No at 1722), the workout is complete and instructions may be provided for the end of the workout, such as cool down instructions (1734) instructing the user to perform stretches etc.

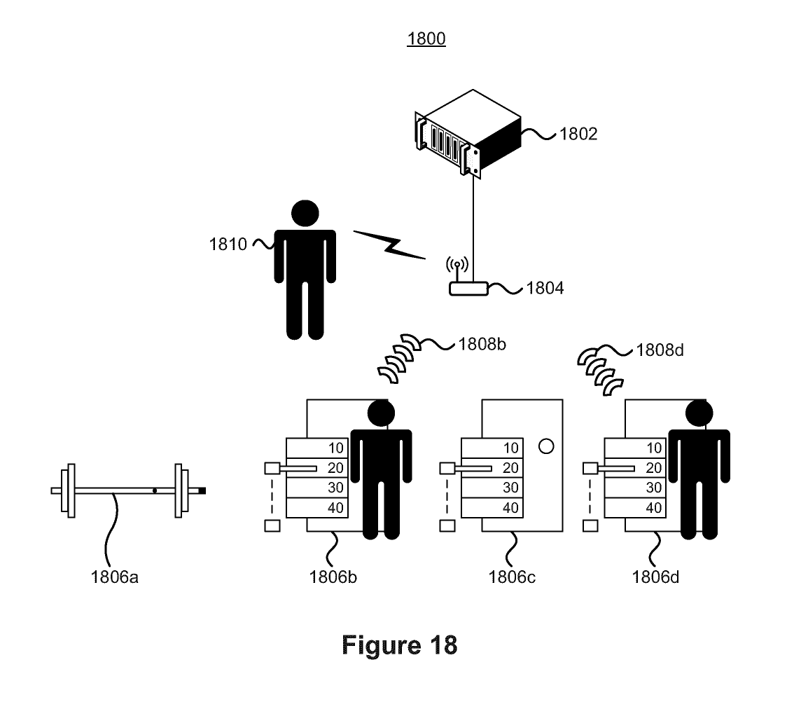

FIG. 18 depicts a system for augmenting workout instructions. The system 1800 comprises a computing device 1802, which may be located within a gym or may be provided over a network, and one or more wireless gateways 1804 that connect to the computing device 1802. The wireless gateways 1804 may include one or more BLE radios for receiving information that is broadcast by the various pieces of equipment. As depicted, the gym is assumed to have a number of pieces of equipment including a barbell 1806a, which may include the removable plate device described above as well as a number of pieces of selectable weight stack machines 1806b, 1806c, 1806d. The selectable weight stack machines may include weight stack selector devices as described above. When in use, the equipment determines workout related information and broadcasts the information along with a identifier of the piece of equipment. As depicted in FIG. 18, the pieces of equipment 1806b, 1806d are in use and as such are broadcasting workout information, depicted as 1808b, 1808d. The broadcast information 1808b, 1808d is received by the wireless gateways 1804 and passed to the computing device 1802. The computing device may process the information to track the usage of the gym equipment, which may be beneficial for maintenance planning as well as replacement or other purchase decisions. Further, the information of which pieces of equipment are currently in use may be used in conjunction with a list of all equipment in the gym in order to determine which equipment is available. A user 1810 may use the availability information, which could be communicated wirelessly, for example using BLE or Wi-Fi, in determining a next exercise to perform. As an example, a user may have a personal computing device providing a guided workout. When the user completes an exercise, the user's personal computing device may determine a plurality of possible exercise that could be performed next and compare the equipment required for the exercises to the available equipment. Accordingly, the workout instructions that may be provided can be augmented in order to adjust the order of exercises based on the availability of equipment.

Various specific details have been described above. While certain features or functionality may be described in particular detail with regard to one device or component, it will be appreciated that the functionality or features may be applied to other devices or components. By way of example, the particular functionality described above for detecting exercise repetitions was described, at least in part, with reference to a wearable computing device. The same or similar functionality could equally be provided in, for example, the removable plate device. Further, while particular communication techniques, such as broadcasting workout related information, may be particularly described with regard to one equipment device, the communication technique may be equally applied to other equipment devices.

It is contemplated that various modifications may be made to the specific embodiments described above. For example, the above has described the use of NFC tags and readers in identifying equipment and devices. The NFC tags and readers may be replaced by other tags and associated readers such as RFID tags/readers, Bluetooth low energy (BLE) tags, or other low power communication technologies such as ANT radios, or ZigBee radios. Further, the above equipment devices have been described as being separate from workout equipment in order to allow the devices to be used with existing workout equipment. However, the equipment device could be manufactured into workout equipment. Similarly, tags used to identify removable weight plates have been described as being affixed to existing weight plates; however it is contemplated that weight plates could be manufactured that incorporate the identifying tags. Further still, while the above has described a wearable device as a bracelet, it is contemplated that the functionality of the bracelet could be incorporated into other wearable devices, including for example clothing that enables detecting movement, as well as possibly determining other information such as muscle tension.

Although various embodiments of the devices, equipment, functionality, etc. are described herein, the description it is intended to provide an understanding of the systems, methods and devices and as such certain aspects may not be described, or not described in as much detail as other aspects. The described systems, methods and devices are not the sole possible implementations, and the various descriptions systems, methods and devices herein will enable one of ordinary skill in the art to apply the teachings to other equivalent implementations without exercising any inventive ingenuity.

What is claimed is:

1. A system for tracking workout related information comprising:
a wearable device comprising:
a wireless communication module; and
a processor for executing instructions stored in memory, which when executed configure the wearable device to:
identify a piece of workout equipment in close proximity to the wearable device; and
receive workout information related to use of the identified piece of workout equipment; and
an equipment device associated with the piece of workout equipment comprising:
a wireless communication module; and
a processor for executing instructions stored in memory, which when executed configure the equipment device to:
determine the workout related information comprising an associated weight being used with the piece of workout equipment; and
transmit the workout information.

2. The system of claim 1, wherein the equipment device is securable to the piece of workout equipment.

3. The system of claim 2, wherein the piece of workout equipment comprises one or more of:
a barbell for receiving removable weight plates; and
a workout machine comprising a number of selectable weight plates.

4. The system of claim 1, wherein the equipment device is a barbell device located at an end of a barbell and further comprise an accelerometer, a gyroscope, or both for providing positioning information for use in determining a motion associated with the use of the barbell, and wherein the workout information transmitted to the wearable device further comprises repetition information indicative of a number of repetitions of the use of the barbell.

5. The system of claim 4, wherein the execution of the instructions by the processor of the equipment device further configure the equipment device to:
process the positioning information from the accelerometer, the gyroscope, or both to determine a repetition count indicating the number of repetitions of the use of the piece of workout equipment, wherein the repetition information comprises the repetition count.

6. The system of claim 4, wherein the repetition information comprises the positioning information from the accelerometer, the gyroscope, or both.

7. The system of claim 4, wherein the barbell device uses one or more of a barcode reader, a near-field communication (NFC) reader, a Bluetooth radio, a Bluetooth Low Energy (BLE) radio, a colour image capture device, or combinations thereof for detecting respective tag on a removable weight plate as the removable weight plate is added to or removed from the barbell over the barbell device, and wherein the instructions when executed by the processor of the barbell device further configure the barbell device to determine the associated weight being used with the barbell using data from the barcode reader, the near-field communication (NFC) reader, the colour image capture device, or the combinations thereof.

8. The system of claim 7 wherein the barbell device further comprises a sensor for determining when the removable weight plate is being added to or removed from the barbell.

9. The system of claim 8, wherein the sensor for determining when the removable weight plate is being added to or removed from the barbell comprises a plurality of capacitive touch sensors spaced apart from each other in a direction the removable weight plate is added to or removed from the barbell.

10. The system of claim 8, wherein the sensor comprises a metal-sensing proximity circuit for detecting proximity of the removable weight plate.

11. The system of claim 10, wherein an identifier of the removable weight plate is compared to identifiers associated with the barbell device to determine if the removable weight plate is being added or removed.

12. The system of claim 1, wherein the equipment device is a weight stack device for securing a selected number of weight plates for use in the piece of workout equipment and comprises a sensor for determining a distance from a reference location that the weight stack device has moved.

13. The system of claim 12, wherein the sensor of the weight stack device comprises an ultrasonic transducer and receiver for determining the distance from the reference location that the weight stack device has moved.

14. The system of claim 13, wherein the weight stack device comprises a floor unit and a pin unit for securing the selected number of weight plates, the ultrasonic transducer and the ultrasonic receiver being located in opposite ones of the floor unit and the pin unit.

15. The system of claim 14, wherein the weight stack device further comprises an infrared (IR) transmitter and an IR receiver, wherein the IR transmitter sends a signal from the pin unit to the floor unit to place the floor unit in an awake mode.

16. The system of claim 12, wherein the weight stack device comprises a range finder device for determining the distance from the reference location that the weight stack device has moved located in a pin for securing a selected number of weight plates or located in a floor unit.

17. The system of claim 16, wherein the range finder device comprises an ultrasonic-based range finder device or a laser-based range finder device.

18. The system of claim 1, wherein the wearable device comprises a near-field communication (NFC) reader and the equipment device or the piece of workout equipment includes an NFC tag identifying the piece of workout equipment to the wearable device.

19. The system of claim 1, wherein the wearable device comprises a Bluetooth low energy (BLE) radio, and the equipment device or the piece of workout equipment includes a BLE tag identifying the piece of workout equipment to the wearable device.

20. The system of claim 1, further comprising an auxiliary equipment device associated with a piece of auxiliary workout equipment comprising:
an equipment device associated with the piece of workout equipment comprising:
a wireless communication module;
one or more sensors for determining auxiliary workout information; and
a processor for executing instructions stored in memory, which when executed configure the equipment device to:
establish a wireless communication path with the wearable device;
determine the auxiliary workout related information from the one or more sensors of the auxiliary equipment device; and
transmit the workout information to the wearable device using the established wireless communication path.

21. The system of claim 1, further comprising a gym management computing device for managing a plurality of the wearable devices and a plurality of the equipment devices.

22. The system of claim 21, wherein the gym management computing device tracks usage of related gym equipment based on received workout information from the plurality of wearable devices.

23. The system of claim 1, further comprising a user interface computing device for providing user access to stored workout information.

24. The system of claim 1, wherein the wearable computing devices establishes a communication channel with the equipment device associated with the identified piece of workout equipment, the communication channel used for transmitting the workout information.

25. The system of claim 1, wherein the equipment device broadcasts the workout information in association with an identifier associated with the identified piece of workout equipment.

26. The system of claim 25, wherein the equipment device broadcasts the workout information in a Bluetooth low energy (BLE) beacon.

27. A removable plate equipment device for use in providing workout related information to a wearable device, the removable plate equipment device comprising:
a housing sized to fit within an opening of a removable weight plate and comprising an end for securing to an end of a weight plate receiving bar;
a plate sensor for detecting when a removable weight plate is being added or removed;
a tag reader for reading an identification tag located at the opening of the removable weight plate of the removable weight plate passing over the tag reader;
a processor for executing instructions stored in memory, which when executed cause the removable plate equipment device to be configured to:
detect when the weight plate is being added or removed and enable the tag reader;
receive a signal from the tag reader and determine an amount of weight associated with the removable weight plate; and
update an amount of weight associated with the weight plate receiving bar; and
a wireless communication interface for transmitting workout information comprising the updated amount of weight associated with the weight plate receiving bar.

28. The removable plate equipment device of claim 27, wherein the tag reader comprises at least one of:
a barcode tag reader;
a QR code tag reader;
an NFC tag reader;
a Bluetooth radio;
a Bluetooth low energy (BLE) radio; and
a colour-coded tag reader.

29. The removable plate equipment device of claim 28, wherein the tag reader comprises an NFC tag reader.

30. The removable plate equipment device of claim 27, wherein the plate sensor comprises:
an outboard plate change sensor for detecting the removable weight plate passing over the outboard plate change sensor; and
an inboard plate change sensor for detecting the removable weight plate passing over the inboard plate change sensor and located between the outboard plate change sensor and the end for securing to the end of the weight plate receiving bar; and
wherein the executed instructions further configure the removable plate equipment device to:
Receive signals from the inboard and outboard plate change sensors, and based on a time of reception determining if the removable weight plate is being added to or removed from the weight plate receiving bar.

31. The removable plate equipment device of claim 27, wherein the plate sensor comprises a metal-sensing proximity circuit for detecting proximity of the removable weight plate, and wherein the executed instructions further configure the removable plate equipment device to:
determine if the removable weight plate is being added or removed based on a comparison of a weight plate identifier to identifiers associated with the removable plate equipment device.

32. A selectable plate equipment device for use in providing workout related information to a wearable device, the selectable plate equipment device comprising:
a pin for selecting a number of plates to be used in a piece of selectable plate workout equipment;
a range finder device for determining a distance from a stationary reference point to the pin during use of the selectable plate workout equipment;
a processor for executing instructions stored in memory, which when executed cause the selectable plate equipment device to be configured to:
receive signals from the range finder and determine a selected amount of weight; and
a wireless communication interface for communicating to the wearable device workout information comprising the selected amount of weight selected by the pin.

33. The selectable plate equipment device of claim 32, wherein in the range finder comprises a transducer and a receiver, one of the transducer and the receiver is located within the pin and the other one of the transducer and the receiver is located within a floor unit.

34. The selectable plate equipment device of claim 33, further comprising an IR transmitter connected to the pin unit and an IR receiver connected to floor unit for providing a wake-up signal from the pin unit to the floor unit.

35. The selectable plate equipment device of claim 34, further comprising an accelerometer in the pin unit for detecting movement and transmitting the wake-up signal upon detecting the movement if the floor unit is not awake.

36. The selectable plate equipment device of claim 32, wherein rangefinder device is located in one of the pin or a floor unit.

37. The selectable plate equipment device of claim 36, wherein the rangefinder device comprises an ultrasonic-based rangefinder device or a laser-based rangefinder device.

38. A method of providing virtual training to a user comprising:
receiving a workout plan for the user identifying a plurality of exercises, one or more of the plurality of exercises comprising an indication of a piece of equipment, and associated weight and a number of repetitions;
providing instructions to the user regarding at least one unperformed exercise of the workout plan;
receiving workout information from a wearable device of the user providing an indication of a piece of equipment being used, an amount of weight be used and repetition information;
comparing the received workout information to the workout plan; and
providing feedback to the user based on the comparison.

39. A near-field communication (NFC) tag comprising:
a body defining an internal opening;
a wire loop antenna surrounding the internal opening of the body; and
NFC circuitry connected to the wire loop antenna.
